(19) United States
(12) Patent Application Publication
(10) Pub. No.: US 2001/0041991 A1
(43) Pub. Date: Nov. 15, 2001

(54) Method and system for managing patient medical records

(76) Inventors: Elliot A. Segal, Bethesda, MD (US); Mark E. Klein, Potomac, MD (US); Ernest W. Kinchen, Baltimore, MD (US)

Correspondence Address: MICHAEL D. BEDNAREK, SHAW PITTMAN, 2300 N STREET, N.W., WASHINGTON, DC, 20037-1128, US

(21) Appl. No.: 09/776,673

(22) Filed: Feb. 6, 2001

Related U.S. Application Data
(60) Provisional application No. 60/181,215, filed on Feb. 9, 2000.

(51) Int. Cl. G06F 17/60

(52) U.S. Cl. 705/3

(57) ABSTRACT

A method and system for providing a medical record management service that supports the creating, storing, accessing, updating, and distributing of patient medical records, especially diagnostic-quality medical imaging, under the control of a patient and the coordinated care of the patient and her physician. According to a representative embodiment, the present invention includes a scanner, a clinical database, an account database, a digitizer, an e-mail server, an image server with an image archive, a web server, an Internet service provider, a web enabler, an expanded memory image archive, and a series of Internet-based software applications and graphical user interfaces that give the patients and physicians access to view and manipulate the information in the clinical database and image archives. The present invention can further include computer-aided detection and a printer capable of producing diagnostic-quality images.

This application claims the benefit of U.S. Provisional Application No. 60/181,215, filed Feb. 9, 2000, which is hereby incorporated by reference in its entirety.

### BACKGROUND

1. Field of the Invention

The present invention broadly relates to the field of electronic commerce, telemedicine, and global network medical record management services. More particularly, the present invention relates to a system and method for creating, storing, accessing, and distributing focused patient medical records.

2. Background of the Invention

A focused medical record is the cornerstone of comprehensive and effective health care. The medical record facilitates patient care by documenting a patient's baseline and providing physicians with the clinical data necessary to detect and successfully treat medical problems in the early stages of development. Often, having a focused medical record that presents a clear and thorough medical history is the difference between recovery and death.

Among health care professionals, a medical record is commonly defined as a repository for information and data collected from a patient's encounter with the health care system. Typically, the structure of the medical record follows a problem-oriented approach, in which each piece of information or data is associated with some specific problem. In addition, a typical medical record is ambulatory, such that ongoing records are appended and updated across multiple visits and treatments. The content of the medical records takes a variety of forms, from handwritten physician notes to diagnostic images such as x-rays and CT (computer tomography) scans.

For the most part, medical records are stored in traditional paper-based formats. The physician maintains a chart on each patient and the patient has individual charts at each of her physicians, e.g., primary care physician, specialists, and sub-specialists. Each chart contains documents such as check-up summaries, vaccinations charts, sick visit summaries, laboratory results, x-ray reports, and prescriptions. Unless a particular medical problem requires the collective care of several physicians and correspondence between them, a patient's charts at individual physicians are rarely integrated and, typically, no one chart contains all of the medical information of the patient. In addition to this lack of integration, the paper-based records also suffer from missing, illegible, redundant, and inaccurate content; unstructured, disorganized, and improperly sorted information; and inefficient access, availability, and retrieval.

To some extent, the application of computer technology to medical record maintenance has alleviated some of the disadvantages associated with paper-based records. Electronic medical records (EMRs) digitally store the information found in traditional paper-based records. Other terms synonymous with EMR are computerized medical records (CMRs) and computer-based patient records (CPRs). As used herein, the term “patient medical record” (PMR) covers these electronic records (EMR, CMR, and CPR) as well as paper-based records. Inherently, these computerized records are more organized, accurate, and accessible in comparison to paper-based records. In addition, the computerized records have the potential to accommodate a greater variety of record media, such as medical imaging and videography.

Counteracting the positive strides made by computer technology, the rise of managed care has often hindered the overall management of medical records. Ironically, in efforts to contain costs, health insurance companies have opted for managed care provided by health maintenance organizations (HMOs), which often restrict access to practitioners. Such restrictions have alienated physicians and patients, resulting in frequent changes in health plans by both physicians and patients. Patients are often directed to physicians who do not have the patient's prior records. Consequently, health care has become increasingly disjointed, making long term physician-patient relationships something of a rarity.

Unquestionably, electronic medical records have simplified the acquisition of and condensed the storage of patient data. However, in the face of multiple health care providers, health care insurance companies, and their corresponding individual computer medical record systems, the EMRs fail to provide centralized and integrated records management. A single patient's EMR is typically fragmented between different health care providers and health insurance providers, with records distributed across multiple repositories. As a result, a physician does not have an integrated view of the patient data, and consequently lacks the comprehensive medical history necessary for efficient and accurate diagnosis and treatment. In addition to de-centralized records, conventional EMRs are usually text-based with limited and inconsistent means of storing clinical images. Thus, not only is the patient's medical data strewn across multiple computer systems, but the physical charts and diagnostic-quality images (on paper) are stored in separate locations.

Recognizing the drawbacks to paper-based medical records and decentralized EMRs, many healthcare institutions and private medical record companies have turned to Internet-based medical record management systems. In fact, commentators largely agree that the future patient record will be a computer-based, multimedia record capable of including free text, high-resolution images, sound, full motion video and elaborate coding schemes, accessible from anywhere around the world. The industry that is cultivating this vision is referred to as telemedicine.

Telemedicine is the use of computers, the Internet, and other communication technologies to provide medical care to patients at a distance. Early forms of this technology involved a simple intranet connection between a hospital and the home of a doctor to facilitate immediate preliminary diagnoses and initial courses of treatment for critical patients brought into the hospital. Later generations of telemedicine incorporated the Internet as a means for distributing medical records to specialists throughout the world for quick and convenient medical referrals. The latest iteration of telemedicine stores medical records and images such as x-rays on the Internet, for access and assessment by physicians such as radiologists. However, this practice of reviewing medical images online, referred to as teleradiology, is generally limited to preliminary “reads” to determine if further investigation is required, and is not suitable for full diagnoses.

Each of these telemedicine approaches focuses on the physician's control and use of the medical records, without regard to the patient's access. In fact, as with all medical records, electronic records are proprietary and their contents are owned by the provider producing the images, such as a hospital, clinic, HMO, or practitioner's office. Thus, compounding the problem of fragmented patient records, patients have no ownership control with which to consolidate the records. Without a personal stake, physicians rarely take the initiative to gather and integrate all records from various physician offices and facilities such as hospitals. In addition, even if a patient is willing to gather and consolidate the large volume of records, the patient lacks the medical knowledge necessary to create a focused patient medical record that contains only the information most relevant to future medical diagnoses and actual care. Thus, frequently the physician directs the patient's medical care without a full knowledge of the patient's medical history, and the patient, without control of the records, has little opportunity to give the physician a complete picture of the medical history.

In an attempt to provide patients with greater control over their medical records, several PMR services provide Internet websites in which to store, update, and retrieve patient medical records. Some of the websites provide medical data management as a primary function while others provide the service as a part of a larger health website. Examples of these websites include epicsys.com™, abaton.com™, medscape.com™, medicalrecord.com™, medbroadcast.com™, TheHealthNetwork.com™, 4healthylife.com™, healthmagic.com™, personalmd.com™, wellmed.com™, webmd.com™, aboutmyhealth.net™, and vistalink.com™. While some websites, such as epicsys.com™ and abaton.com™, provide PMR services for health groups (e.g., health administrators, clinicians, and hospitals), the remaining websites, as well as the present invention, target the consumer, or patient, and give the patient ownership and control of the medical records.

The websites providing PMR services to patient consumers share one or more of the following functions: 1) provide website features and structured tabs that emulate paper-based medical charts; 2) give the patient control of the creation, maintenance, and distribution of medical records; 3) store laboratory results, specialist reports, and EKG (electrocardiogram) copies; 4) match physicians of a participating primary physicians network to patients in need of medical advice and treatment; 5) provide patient consumers with technical advice concerning creation of medical records and use of website features; 6) enable physicians to view and update medical records with permission of the patient; and 7) provide key information for emergency situations.

In addition to these typical functions, one website, vistalink.com™, offers the expanded capability of storing images such as x-rays, digitized x-rays, magnetic resonance imaging (MRIs), CT scans, and ultra-sounds. However, as especially relevant to the present invention, these digital images do not attain the quality required for accurate diagnosis. For example, vistalink.com™ offers one megabyte of storage and suggests that an x-ray JPEG image of 42 kilobytes is sufficient for assessment by a physician. However, true diagnostic x-rays require on the order of 32 megabytes of uncompressed storage or 4 megabytes of compressed storage. In addition, as another example, a full mammography x-ray series, which is required for an accurate diagnosis, requires on the order of 168 megabytes of storage. Thus, none of the current PMR services provide diagnostic-quality medical imaging.

In addition to inadequate image capability, the prior art web-based PMR services suffer from several more significant shortcomings. First, although the websites give patients control of medical records, no website appears to facilitate an interactive exchange between a patient and primary care physician. Although some websites enable physicians to view and update records, none use an interactive exchange to allow the physician to act as a patient care coordinator of key medical information. In light of the voluminous records associated with the typical patient, these websites lack the physician guidance necessary for patients to determine which records should be included in a focused patient medical record. In other words, the prior art websites fail to facilitate a partnership between patient and physician that creates, maintains, and uses a completely integrated and focused medical record to assess and monitor the patient's health and to take appropriate action.

Second, web-based PMR services provide limited means of conveying key medical information in emergency situations. As noted above, most services provide a summary of critical medical information through website postings. Typically, in an emergency, the patient herself or a user card on the patient gives the medical professional the patient's account access information. The medical professional must then log on to the Internet, locate the appropriate website, traverse the access steps (e.g., username and patient identification), and view the critical information. Although the medical professional eventually does receive the critical information, frequently in emergencies it is received too late. Therefore, plainly stated, the prior art web-based PMR services lack an immediate means of communicating critical medical data.

Third, the prior art web-based PMR services fail to meet the specific needs of routine mammography studies. Specifically, the prior art websites lack the ability to store, retrieve, and transmit a series of diagnostic-quality mammograms that are owned and controlled by the patient. Mammography is the only diagnostic procedure proven to save lives by early detection of breast cancer. American Cancer Society guidelines recommend that women over the age of 40 undergo annual mammography. After an initial baseline image, each annual mammogram documents any gradual changes. Therefore, having a consistent series of regular mammograms is crucial to identifying suspicious areas and prescribing early intervention. In addition, accurate identification of problems, by medical professionals and computer-aided detection (CAD), relies on the original mammograms or copies of equal diagnostic quality. As discussed above, the prior art websites do not provide this quality.

In addition to inferior quality, the prior art website lack procedures for acquiring the routine mammogram, storing diagnostic-quality mammograms in a central location, and retrieving and transmitting the images for evaluation by remote medical specialists.

### SUMMARY OF THE INVENTION

The present invention, referred to herein as Patient Power™, is a method and system for creating, storing, accessing, updating, and distributing patient medical records, especially diagnostic-quality medical imaging, under the control of a patient and the coordinated care of the patient and physician. Broadly stated, the present invention provides centralized and focused online medical record storage, facilitates a patient-physician partnership by which to create and maintain the focused online medical records, provides means for obtaining and storing diagnostic-quality images, establishes Internet-based communication through which to transmit medical records, provides immediate means for conveying critical medical information in emergency situations, and provides means for storing, receiving, and transmitting diagnostic-quality mammograms.

According to a representative embodiment, the components of the present invention are a scanner, a clinical database, an account database, a digitizer, an e-mail server, an image server with an image archive, a web server, an Internet service provider (ISP), a web-enabler, an expanded memory image archive, and a series of Internet-based software applications and graphical user interfaces (GUIs) that give the patients and physicians access to view and manipulate the information in the clinical database and image archives.

The scanner, which could be a facsimile machine, digitally encodes images of paper documents, such as EKGs, into computer files that are capable of creating legible or readable images, but not necessarily diagnostic-quality images. The clinical database stores scanned documents, such as EKGs and special reports, and textual information that are entered directly into a computer. The account database stores the contact, demographic, and financial information associated with each patient, such as name, address, phone number, social security number, and date of birth. The digitizer digitally encodes medical images, especially radiological images such as x-rays, into computer files capable of producing diagnostic-quality images on computer monitors. The image server receives the digitally encoded medical images from the digitizer and transmits them either to the image archive or the expanded memory image archive for storage, or to remote computer terminals for display and analysis. Finally, the e-mail server, the web server, the web-enabler, the GUIs, and the ISP facilitate web-based communication, including the transmission of medical records.

In the preferred embodiment of the present invention, monetary incentives encourage a network of participating physicians, preferably primary care physicians and radiologists, to assist patients in creating a medical record that is streamlined and focused, containing only the information most relevant to current health conditions and future diagnoses and care. The present invention pays primary physicians for approximately 2 to 3 short consultations a year (during regular office visits), aimed at deciding what data should be included in and excluded from a patient's medical record. For example, if a patient mistakenly omits a chronic condition such as a diabetic ulcer, the physician would direct the patient to include it in the medical record. As another example, if a patient recently underwent heart bypass surgery that produced hundreds of documents, the physician would summarize the event for entry into the medical record. Under the physician's guidance, the patient enters the data into the medical record and owns and controls the entire medical record. In the end, the patient owns a focused medical record that enables the primary physician and other specialists to make efficient medical assessments based on concise medical records.

As the owner of the medical record, the patient has the option of giving a doctor access to view and update the information. In this manner, the present invention allows a patient to work with her primary physician in maintaining a focused medical record. A direct benefit of this partnership is that the primary physician is aware of all critical medical data at all times, and as a result, can make informed accurate medical decisions, and can more efficiently direct the overall health care of the patient.

In the preferred embodiment of the present invention, a patient first registers with a system operator for the service, providing basic background information, such as address, occupation, and age. This registration can occur by facsimile correspondence (e.g., from a doctor's office) or by online interaction through a series of registration GUIs (e.g., from the patient's home). Alternatively, a patient can register by calling a telephone call center, which is staffed by nurses or other healthcare professionals. The telephone call center could also use an interactive voice response (IVR) unit for registration. Once registered, the system operator gives the patient a username and unique patient identifier (UPI), establishes an account under the patient's name in the account database, and creates a file in the clinical database, ready to accept medical record information.

Once the patient is registered, the present invention provides means for entering data into the patient's medical record. The data is in three primary forms: 1) textual records; 2) scanned records, such as EKGs and special reports; and 3) medical images, such as x-rays. With guidance from the patient-physician partnership described above, an authorized user, who may be, for example, the patient, a relative of the patient, or the patient's physician, enters textual information through an online Internet connection that interfaces with the GUIs and the web server. The web server stores in the clinical database the textual data received through the GUIs. For scanned records, the scanner (or a facsimile machine) digitally encodes the original documents and stores the encoded files in the clinical database. For medical images, which require diagnostic quality (significantly higher than the quality required for the scanned documents), the digitizer digitally encodes an original medical image in a high-resolution format file. The image server receives the file and transmits the file to the archives for storage.

With the data entered into the medical record, the present invention further provides means to retrieve and transmit the medical data. A user with authorized access to the medical record (e.g., the patient or her relative or primary physician) interfaces through an online Internet connection with the GUIs provisioned on the web server. The GUIs prompt the user to initiate a query to the web server for the desired medical record. If the desired record is a textual document or a scanned document, the web server consults the clinical database, retrieves the record, and transmits it back to the user. If the desired record is a diagnostic-quality image, then the web server queries the image server to retrieve the diagnostic-quality image from the archives. The image server returns the medical record to the web server and the web server transmits the record back to the user. If the size of the digitally encoded file for the diagnostic-quality image is too large for efficient Internet transmission or the user does not have hardware capable of supporting diagnostic-quality resolution, the present invention also provides means for printing a hard copy of the image (e.g., a laser printer) and returning the hard copy to the user by conventional means, e.g., U.S. Mail. For each of these record retrieval methods, the present invention can return the record to the user or to a destination chosen by the user (e.g., a distant medical specialist for a referral or second opinion).

By enabling the storage and management of diagnostic-quality images, the present invention meets the specific needs of routine mammography studies. To further meet these needs, the present invention uses the GUIs to establish special records for tracking the routine mammograms. In addition, the present invention incorporates computer-aided detection to improve the accuracy in detecting early signs of disease.

Another important aspect of the present invention is the provision of an immediate means for communicating critical medical data. Once the patient has entered the medical data, the present invention marks the information most critical for an emergency situation. A single, concise GUI displays this critical information. Further, as an advantage over the prior art, the present invention provides a Patient Power Emergency Room Carrier (PERC) that stores the critical information in a portable form. In this manner, the patient carries the PERC at all times, e.g., the PERC would be stored in a memory card, such as a smart card, a flash card, a compact flash card, or a personal information carrier (PIC), which could be attached to a key chain or other device. The card is compatible with hospital computer terminals, e.g., using PCMCIA interfaces provisioned at each hospital. Thus, instead of requiring the emergency room staff to log onto the Internet and access the critical information page, the PERC enables instant plug-in and display capability. In addition, in an alternate embodiment, the memory card includes a patient's entire medical record that appears behind the critical information. This memory card, containing a total patient record, is referred to herein as Super PERC (Patient Power Electronic Record Carrier).

As a side note, it should be recognized that the term “computers” as used herein is intended to have the broadest possible meaning to encompass a portion of a computer, a single computer, or one or more computers in communication with each other. Indeed, one of the principal advantages of the present invention is that it can be implemented on any variety of computer network systems.

Accordingly, an object of the present invention is to provide a convenient, efficient medical data acquisition, management storage, and retrieval network.

Another object of the present invention is to create a network of participating primary physicians and radiologists.

Another object of the present invention is to give health consumers more control over their own medical care.

Another object of the present invention is to provide a PMR service to consumers who travel frequently, who have or are susceptible to chronic illnesses, and who need to centralize key medical data.

Another object of the present invention is to provide procurement, storage, and management of mammogram records for women who undergo mammography, to insure the availability and security of their mammograms and the capability of identifying breast abnormalities by computer-aided detection.

Another object of the present invention is to give each subscriber control over her medical information by providing the subscriber and her physicians with immediate and continuous access to that subscriber's relevant current medical information and past medical history, to enable that individual to receive the most efficient and appropriate medical care.

Another object of the present invention is to enhance the relationships between each subscriber and her physicians, by allowing them to work together to keep the critical information necessary for optimum medical care current and accessible.

Another object of the present invention is to provide a safe, permanent digital storage system for a woman's mammograms and for the patient's other significant medical images (X-rays, other radiological examinations), which can be conveniently retrieved and forwarded to the subscriber or her designated medical professional in a timely manner.

Another object of the present invention is to improve the quality, accuracy, and efficiency of a health care system.

Another object of the present invention is to lower health care costs by reducing the number of unnecessary hospital admissions and minimizing the duplication of diagnostic tests and procedures.

Another object of the present invention is to empower patients, permitting them to become more knowledgeable health care consumers and to better control their health care.

Another object of the present invention is to eliminate the considerable anxiety and unnecessary procedures, including surgical intervention, created by lost or unavailable mammographic studies.

Another object of the present invention is to allow for the use of computer-aided detection to further evaluate a mammogram.

Another object of the present invention is to create a simple and reliable mechanism for permitting transmittal of mammograms for second opinions or additional evaluation.

Another object of the present invention is to give women control of their mammograms and mammography reports.

As described herein, the present invention comprises a system and method that includes at least the following significant features:

1) a digitizing procedure that obtains diagnostic-quality medical imaging for storage in a patient's medical record;

2) a clinical database that stores textual and scanned documents;

3) image archives that store diagnostic-quality images;

4) a process for managing patient medical records that gives the patient ownership and control of the records, forms a partnership between physician and patient that promotes coordinated care, and provides incentives for the physician to assist the patient in creating a streamlined, focused medical record;

5) a portable medical data storage that immediately communicates critical medical data for emergency situations (PERC);

6) a portable medical data storage that contains most or all of a patient's medical record (Super PERC);

7) a unique patient identifier; and

8) a process for managing routine mammography studies.

These and other objects and advantages of the present invention are described in greater detail in the detailed description of the invention, the appended drawings, and the claims. Additional features and advantages of the invention will be set forth in the description that follows, will be apparent from the description, or may be learned by practicing the invention.

### DESCRIPTION OF THE DRAWINGS

FIG. 1 is a schematic diagram of the system architecture of the present invention.

FIG. 2a is a preferred site map of the present invention.

FIG. 2b is an image of the preferred website home page of the present invention.

FIGS. 2c-2f are images of screens giving contact information and company information about the medical record management service provider.

FIG. 2g is an image of a “help” screen.

FIG. 2h is a chart listing the structured tabs presented on the My Medical Folder, Global-ER, MammoTracker, and MammoNet screens.

FIG. 3a is a schematic diagram illustrating patient account registration.

FIGS. 3b-3i are images of screens that the system displays during patient account registration.

FIG. 4 is a schematic diagram illustrating the method by which medical records are entered into the patient medical record service.

FIGS. 5a-5ah are images of the various screens that the system provides to a patient during entry of textual and scanned documents.

FIG. 6 is a schematic diagram illustrating the entry of diagnostic-quality non-mammography images.

FIGS. 7a-7c are schematic diagrams illustrating the entry of diagnostic-quality mammography images.

FIGS. 7d and 7e are a flowchart outlining the general workflow of the acquiring mammograms and storing them in patient medical records.

FIGS. 8a and 8b are schematic diagrams illustrating the methods by which the present invention retrieves medical records.

FIG. 9 is a schematic diagram illustrating the customer service and technical support provided by the present invention.

### DETAILED DESCRIPTION OF THE INVENTION

The present invention, sometimes referred to herein as Patient Power™, is a system and method for providing web-based medical record management for patients. As an overview of the present invention, the following discussion describes the architecture and components of the system, and the business procedures and website operation that registers, establishes, and manages patient medical record accounts. This description of a system architecture and a method for implementing a medical record management service within that architecture are examples of preferred embodiments of the present invention. While the method described herein and illustrated in the figures contains many specific examples of information flow steps, these steps should not be construed as limitations on the scope of the invention, but rather as examples of information flow steps that could be used to practice the invention. As would be apparent to one of ordinary skill in the art, many other variations on the system operation are possible, including differently grouped and ordered method steps. Accordingly, the scope of the invention should be determined not by the embodiments illustrated in these examples, but by the appended claims and their equivalents.

System Architecture

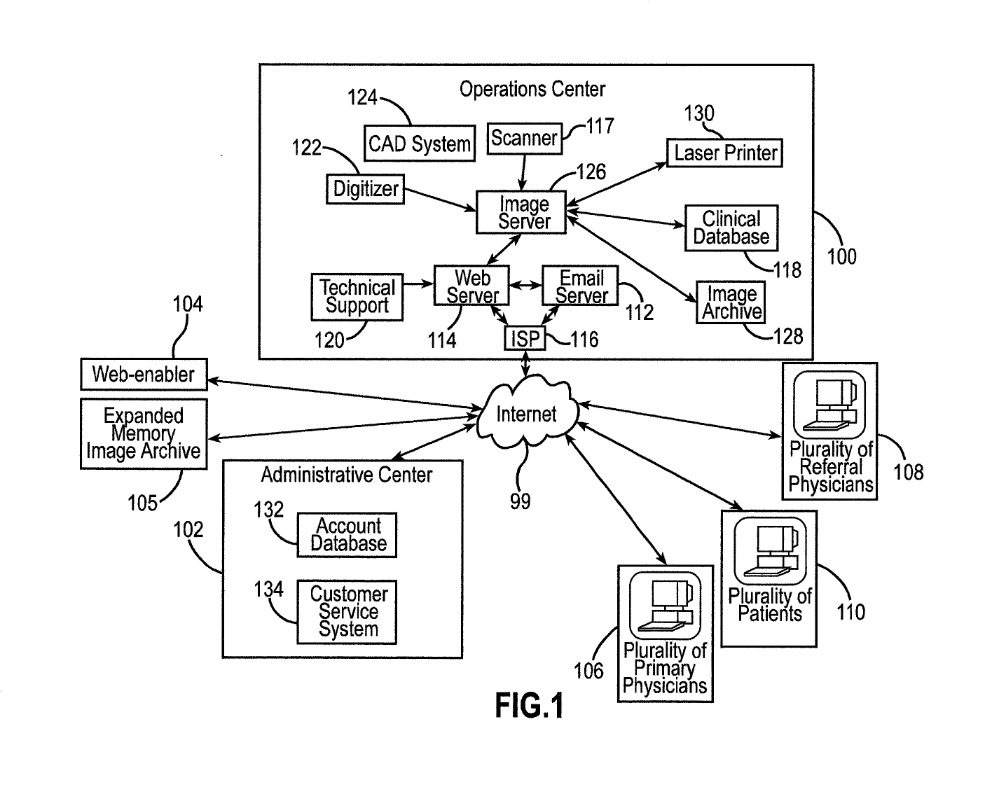

Referring to FIG. 1, the present invention uses the Internet 99 to link together an operations center 100, an administrative center 102, a web-enabler 104, an expanded memory image archive 105, a plurality of primary physicians 106, a plurality of referral physicians 108, and a plurality of patients 110. Operations center 100 provides all of the technical support, quality assurance, and backroom services required to support the features of the present invention. To meet these needs, operations center 100 includes an e-mail server 112, a web server 114, an Internet service provide (ISP) 116, a scanner 117, a clinical database 118, a technical support system 120, a digitizer 122, a computer-aided detection (CAD) system 124, an image server 126, an image archive 128, and a laser printer 130.

E-mail server 112, web server 114, and ISP 116 interface with Internet 99 and enable web communication among operations center 100, administrative center 102, web-enabler 104, expanded memory image archive 105, the plurality of primary physicians 106, the plurality of referral physicians 108, and the plurality of patients 110. Clinical database 118 stores medical data and scanned document files in separate accounts for each patient. Technical support system 120 provides assistance to users of the system concerning hardware, software, website interface, file transfers, e-mail, and other technical problems.

Scanner 117, which could be a facsimile machine, digitally encodes images of paper documents into computer files that are capable of creating legible or readable images, but not necessarily diagnostic-quality images. Digitizer 122 digitally encodes original medical images into computer files capable of reproducing diagnostic-quality images.

CAD system 124 supplements radiological studies by digitally analyzing images for indications of disease and marking such indications for further analysis by, for example, an interpreting radiologist. Image server 126 receives the digitally encoded files from digitizer 122 and CAD system 124, and transmits them to image archive 128 or expanded memory image archive 105 for storage. Expanded memory image archive 105 provides storage, archiving, security, backup, and transmission services for digital images. Wam!Net™ of Minneapolis, Minn. is an example of a suitable service provider for expanded memory image archive 105. Laser printer 130, which is capable of diagnostic-quality printing, furnishes hard copies of the digitally encoded images and records.

Administrative center 102 contains an account database 132 and a customer service system 134. Account database 132 contains personal information for each subscriber, which is linked to the patient's medical data stored in clinical database 118. Customer service system 134 provides assistance for all non-technical subscriber problems, e.g., billing questions.

Web-enabler 104 receives diagnostic-quality images from image server 126. In addition to storing the images on a short-term basis (up to 30 days), web-enabler 104 “web-enables” the files for further transmission through Internet 99. Among other things, web enabling involves compressing a file and placing the file in a database at a particular address and location for later accessing of the file.

Expanded memory image archive 105 receives diagnostic-quality images requiring large amounts of memory storage. For example, mammography studies, requiring on the order of 168 MB each, preferably would be stored in expanded memory image archive 105.

The plurality of primary physicians 106, including primary doctors' offices and radiological imaging centers, provides consultations with patients to assist in formulating focused medical records. The plurality of primary physicians 106 also serves as a location for registering patients, by for example e-mail, telephone, or facsimile machine. Finally, the plurality of primary physicians 106 also accesses and updates patient medical records, as authorized by the patients.

The plurality of referral physicians 108 includes specialists and radiologists who receive through the Internet 99 medical records for further analysis, e.g., second opinions. The plurality of referral physicians 108 may also access and update patient medical records if authorized by the patient.

Finally, the plurality of patients 110 access their individual medical records through the Internet 99 from home or another personal Internet access workstation, or from an Internet access workstation at a primary physician location.

The preferred embodiment of the present invention is implemented as a website-accessible database on the Internet that gathers and disseminates information related to patient medical records. Users, e.g., patients and physicians, can access clinical database 118, account database 132, image archive 128, web-enabler 104, and expanded memory image archive 105 via the website. A user enters the appropriate website address (e.g., URL) to obtain access to these databases. Using a series of web pages (described below), users can enter, modify, and obtain information contained in the server databases.

According to a preferred embodiment, the hardware components of the system include three servers, a backup device, and remote access hardware (e.g., modem, encrypted TCP/IP access). The three servers, e-mail server 112, web server 114, and image server 126, are preferably Micron NetFrame 3100/500 Mhz processor servers with 512 MB RAM, and 20 GB storage (50 GB minimum for image server). Operating on the hardware, the preferred software includes Windows NT Server 4.0 (SP5), Internet Information Server 4, Cold Fusion 4.01, Microsoft Access 2000, and SQL Server.

Although FIG. 1 shows servers, archives, and databases as separate network components, one of ordinary skill in the art would appreciate that these components could be combined into fewer components or into a single component with distinct applications, to accomplish the individual functions of each component. For example, clinical database 118 and image archive 128 could be a single database segmented to handle the files stored by clinical database 118 and image archive 128. As another example, scanner 117 and digitizer 122 could be single machine providing the functions of both scanner 117 and digitizer 122.

System Operation

Implemented within the above-described system architecture, the present invention provides a method for establishing and managing patient medical records, including specialized mammography studies. This method involves a general business procedure supported and facilitated by interactions through a website. For clarity, the following discussion first describes generally the features of the present invention, and then traces the specific business procedures and website operation through the logical progression of establishing and managing a patient medical record.

Features

In providing a medical record management service, the present invention offers the following general features: 1) My Medical Folder; 2) Global-ER; 3) MammoTracker; and 4) MammoNet.

My Medical Folder is a software application designed to assist a patient in working with a primary physician to establish a focused medical record. The structure of My Medical Folder generally corresponds to a traditional medical chart and is designed to prompt the patient and physician for information necessary for future diagnoses and care. According to a preferred embodiment, physicians are offered monetary incentives (e.g., 2-3 paid consultations per year) to assist patients in entering and maintaining medical records in My Medical Folder.

Global-ER is a software application that presents the most critical information necessary in an emergency situation. Having readily available, clear information avoids unnecessary and costly medical procedures, and increases the probability of obtaining successful treatment. Although described herein as a part of My Medical Folder, Global-ER is also a stand-alone feature, providing key emergency information to, for example, customers of health care Internet portal companies, health care service payors (e.g., HMOs, Preferred Provider Organizations (PPOs), and large employers), pharmaceutical benefit management companies, and disease-management companies. Additionally, as a further embodiment of Global-ER, the critical information stored in Global-ER is downloaded onto a portable PERC to be carried at all times by the patient. In a related embodiment, the entire My Medical Folder or a portion thereof is downloaded onto a portable Super PERC to be carried by the patient.

MammoTracker is a software application that collects and tracks information (but not images) related to breast imaging and procedures, such as mammograms, breast ultrasound examinations, and biopsy procedures. MammoTracker retains a series of prior mammogram results to aid detection of early indicators of problems and accurately track progress toward malignancy. MammoTracker can operate as a stand-alone application or can be integrated with either My Medical Folder, MammoNet, or both.

Finally, MammoNet is a system that acquires, stores, archives, tracks, and retrieves mammographic studies (i.e., diagnostic-quality images). MammoNet stores mammograms as digitally encoded files in an expanded memory archive. Depending on the Internet communication and display capabilities of a particular implementation of the present invention, a patient can electronically transmit the diagnostic-quality images to physicians for review or can print them out and deliver them as hard copies. Also, depending on these technical capabilities, MammoNet can either be a stand-alone system or can be integrated with My Medical Folder or MammoTracker or both, such that a patient can not only view and update summaries of mammography studies, but can also retrieve and view the images associated with each study.

Business Procedures and Website Operation

In light of the general features of the present invention described above, this section tracks a patient's enrollment and use of the system and method of the present invention. The system and method include the following principal functions: 1) patient account registration; 2) medical data entry; 3) medical data retrieval and transmission; and 4) customer service and technical support. For each of these functions, the discussion below explains the actions taken by the patients and physicians, the interaction between the system components, and the concurrent operation of the website, most often depicted by screen shots that the user views at each step.

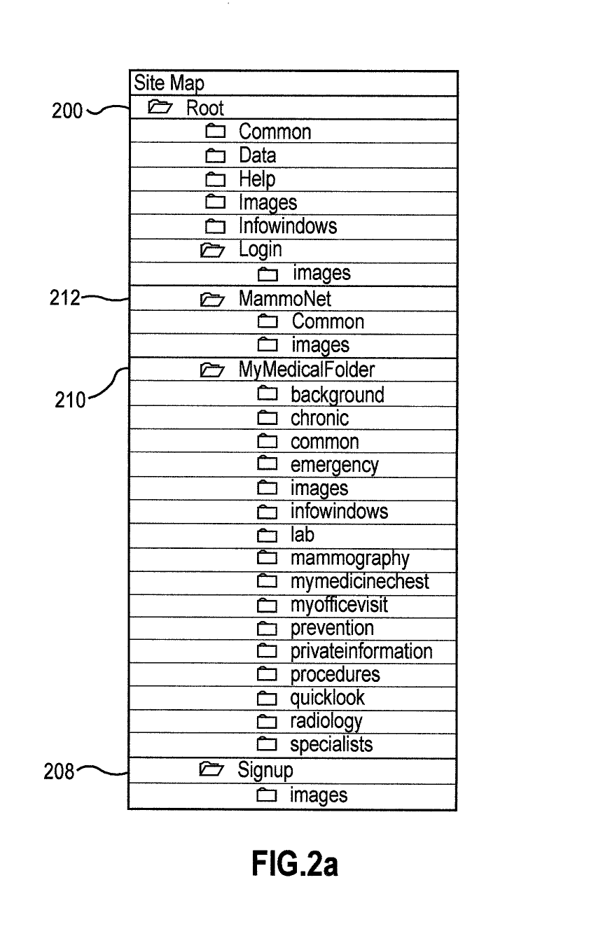

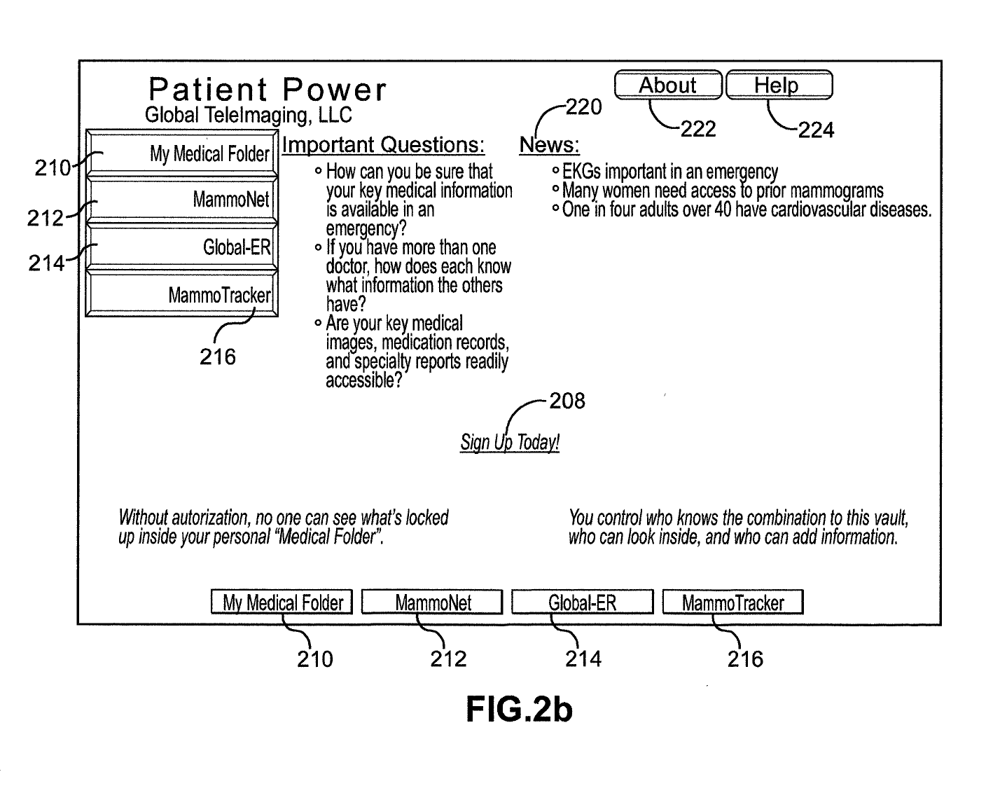

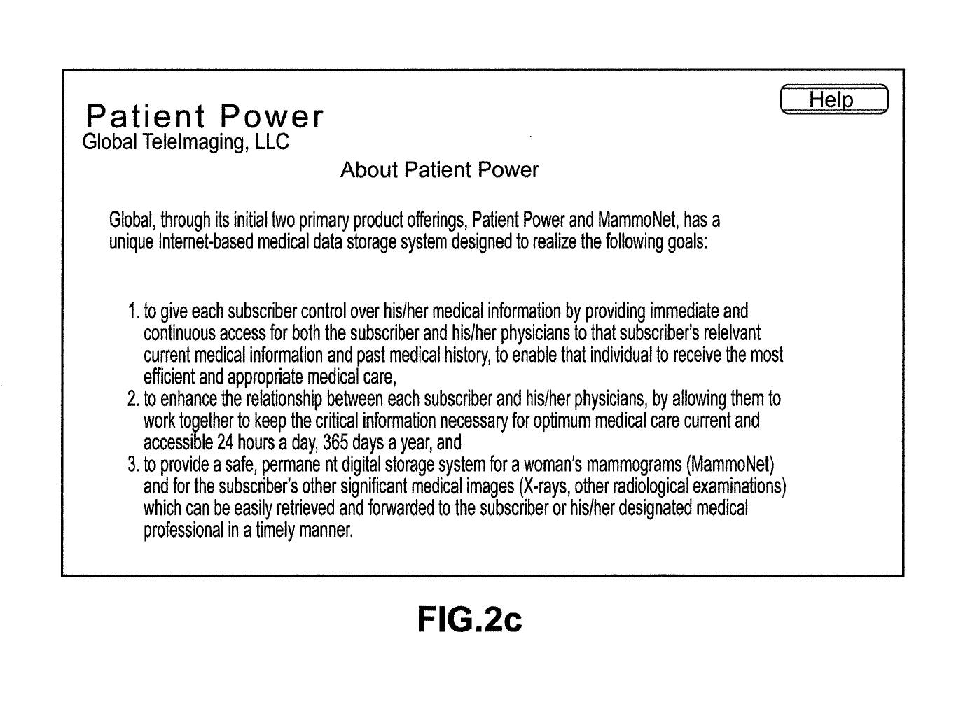

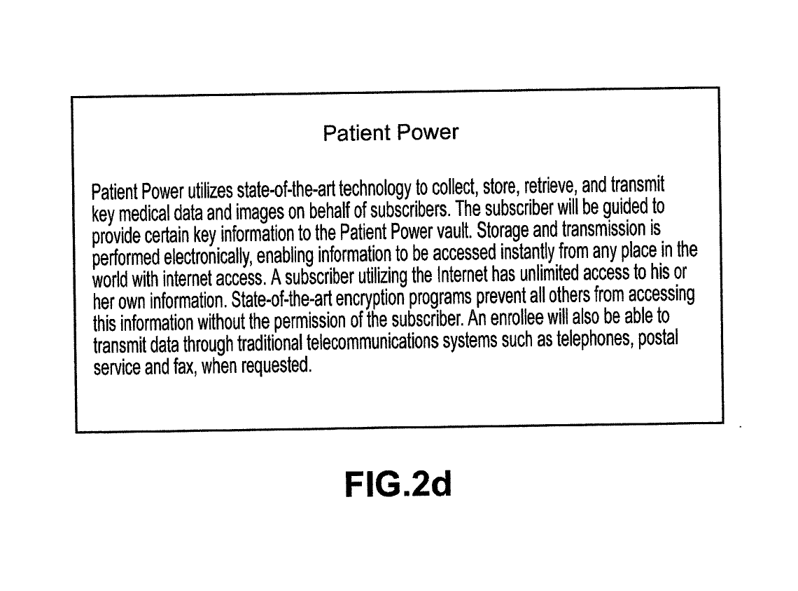

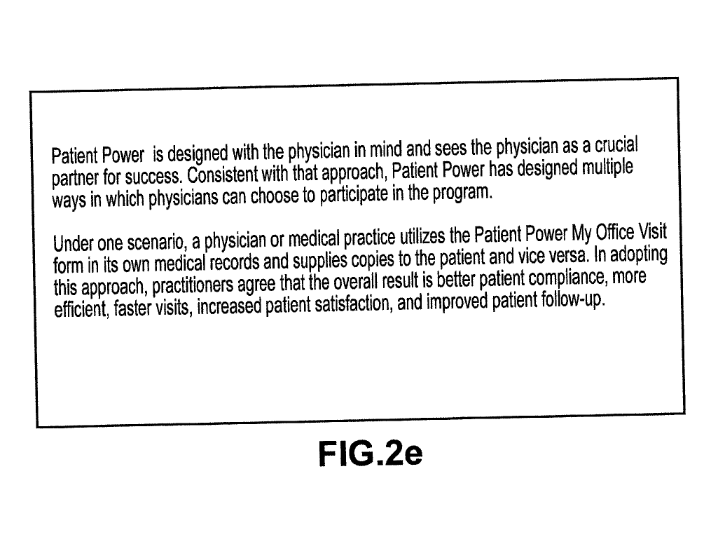

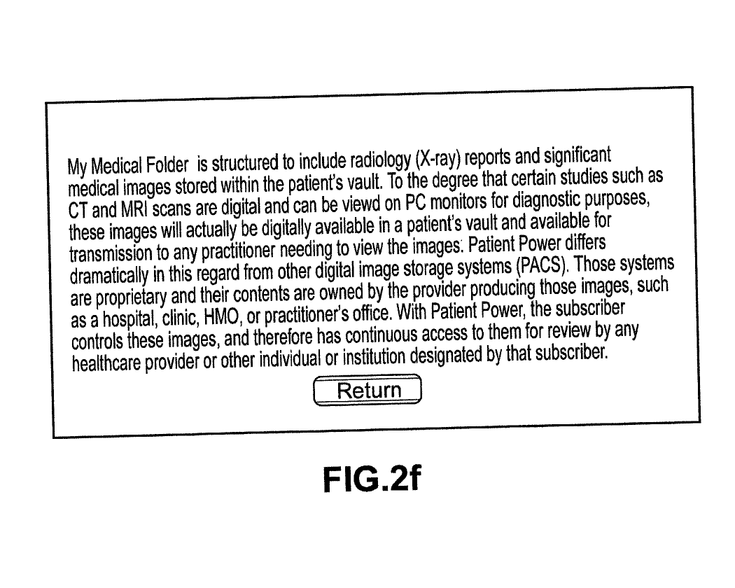

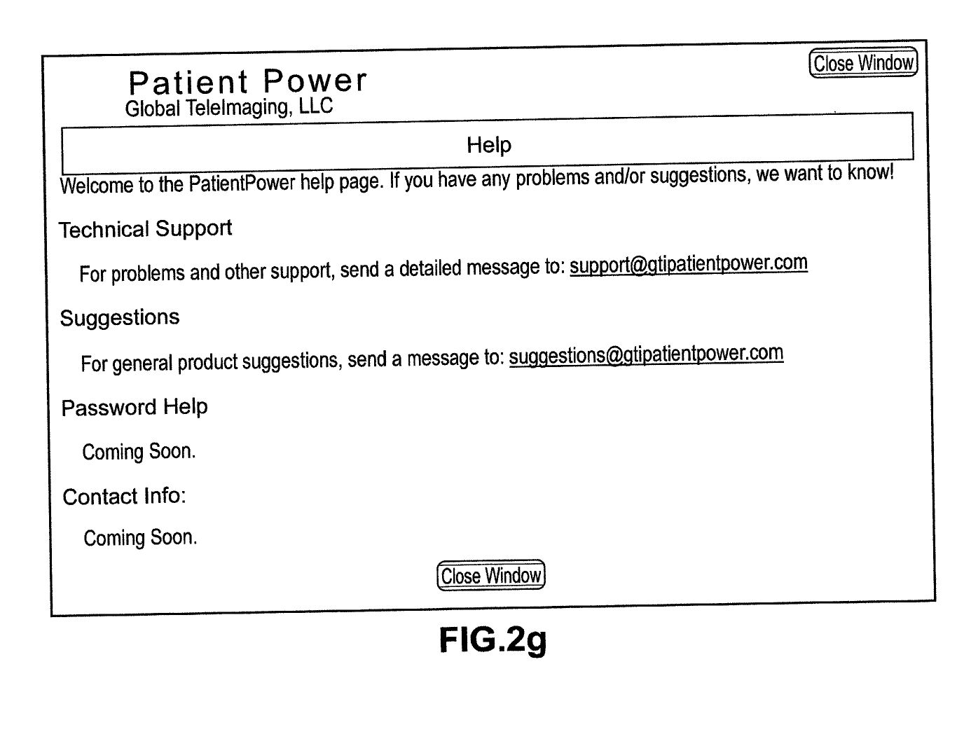

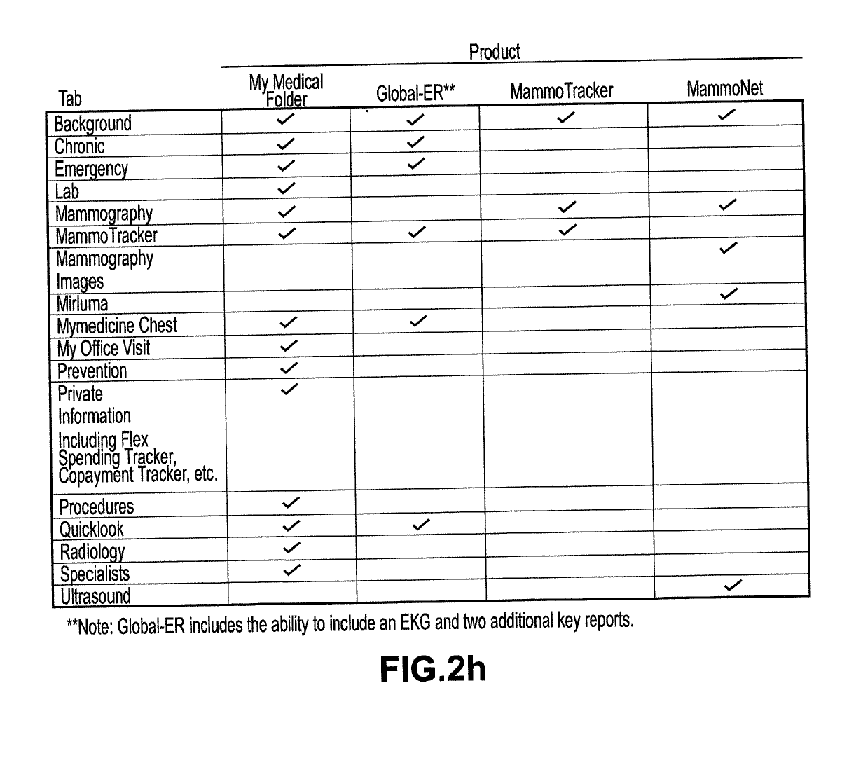

As an overview, FIG. 2a illustrates the preferred site map of the present invention. When a user, e.g., a patient or physician authorized by the patient, first enters the website, the system displays a home page, as is represented by the root directory 200 of the site map in FIG. 2a. As FIG. 2a shows, the user can enter five different menu options: Sign Up 208 (account registration), My Medical Folder 210, MammoNet 212, Global-ER (which is in the same root directory as My Medical Folder), and MammoTracker (which is also in the same root directory as My Medical Folder).

FIG. 2b shows a representative embodiment of the home page that is displayed upon entry into the website. The home page contains introductory information regarding the site, some explanatory remarks, and several option buttons. Preferably, the user navigates through the system using the options presented on the home page. Preferably, the home page displays to the user a number of options (e.g., in the form of buttons, or highlighted or underlined text, displayed on the home page, which are clicked-through to make a selection).

For example, as shown in FIG. 2b, a Sign Up button 208 activates the patient registration GUI. Clicking on My Medical Folder button 210 activates the GUI that presents data fields into which medical data is entered, for storage in the clinical database 118. The Global-ER 214 and MammoTracker 216 buttons display particular subsets of medical data taken from My Medical Folder 210. Global-ER 214 presents data on the most critical information necessary in emergency situations, such as background information, chronic conditions, emergency precautions, and information on current medicines that the patient is taking. MammoTracker 216 presents only mammography data. Clicking on MammoNet 212 launches the application that manages diagnostic-quality mammography studies. Finally, the home page preferably features three additional buttons for information links 220 (e.g., hyperlinks to related news information), “about us” information 222 (e.g., giving contact information and company information about the medical record management service provider, examples of which are shown in FIGS. 2c-2f), and “help” information 224 (e.g., simple technical instructions for navigating website, an example of which is shown in FIG. 2g).

The home page acts as the gateway to the functions of the present invention. Clicking on the buttons brings up more screens with more options, presented as structured tabs. At any point during interaction with the website, the user can return to previous screens by clicking the options buttons. Alternatively, the applicant can use the “go to” or “back and forward” features of an Internet browser application. FIG. 2h illustrates the structured tabs presented on the My Medical Folder, Global-ER, MammoTracker, and MammoNet screens.

1) Patient Account Registration

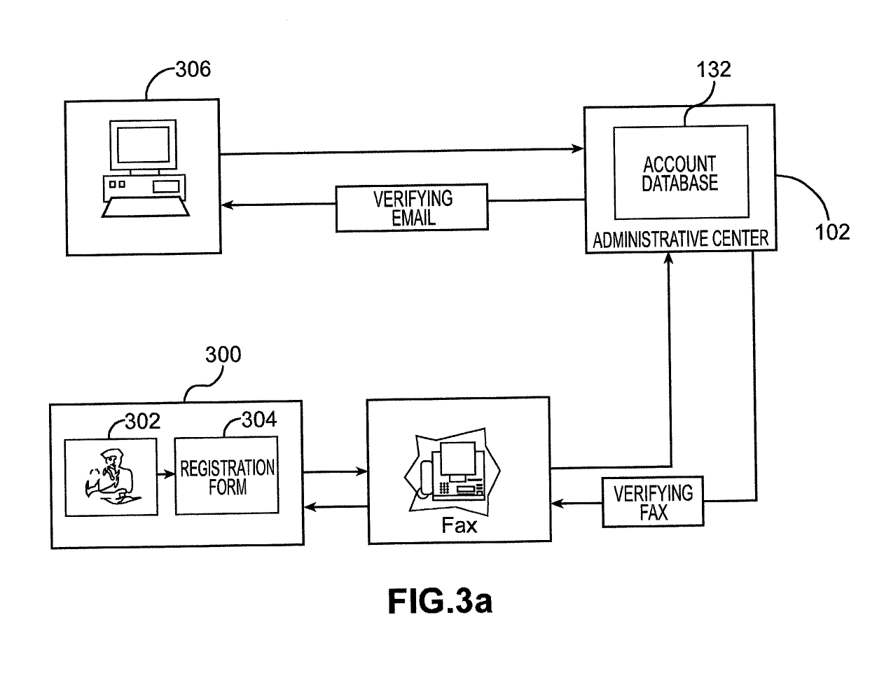

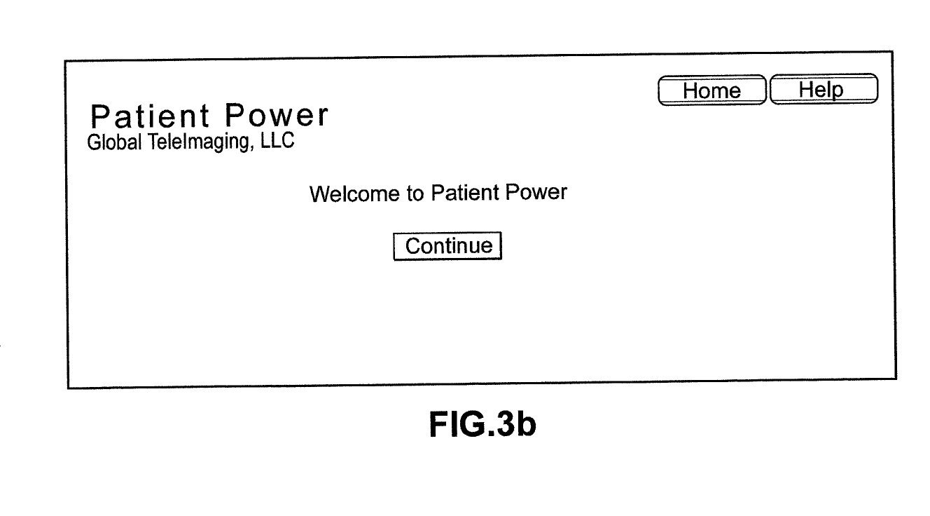

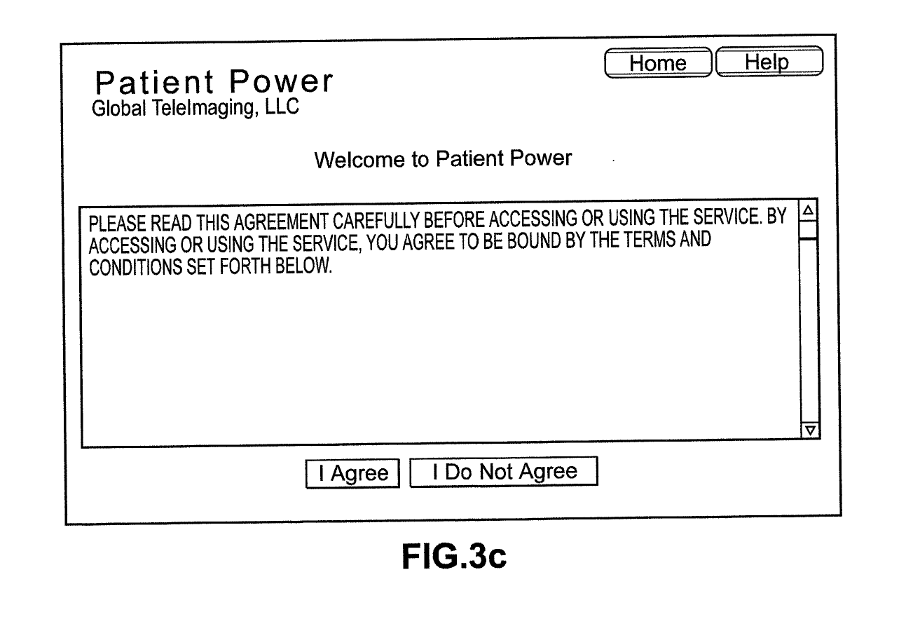

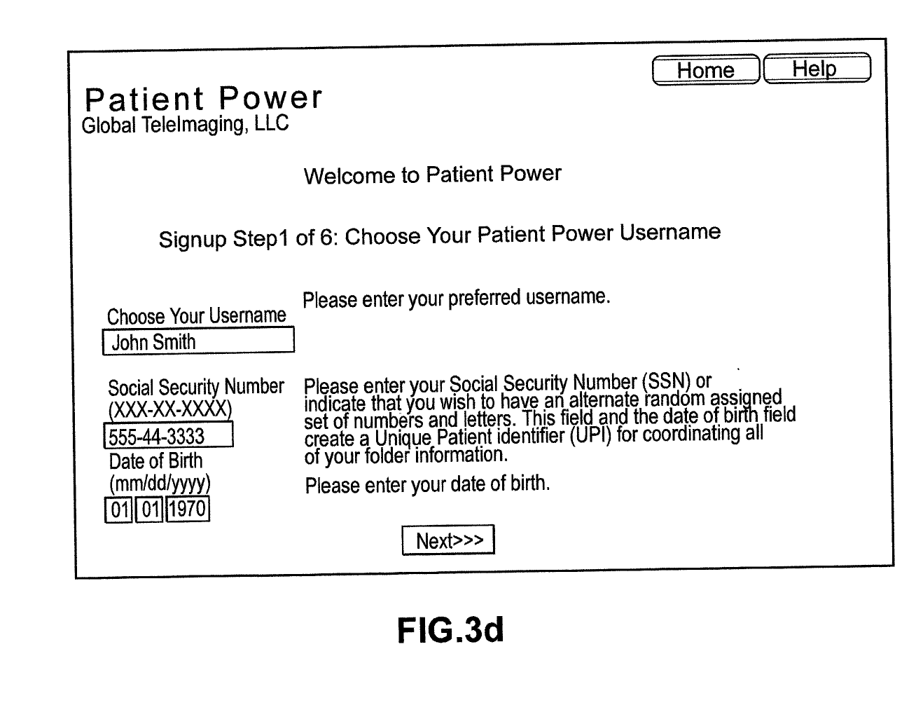

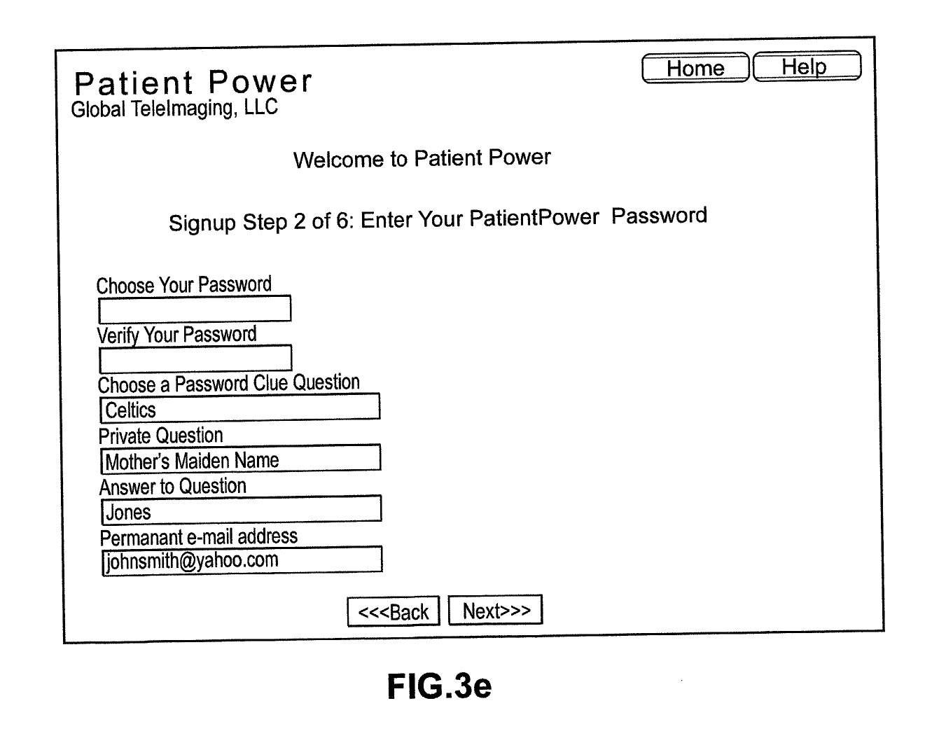

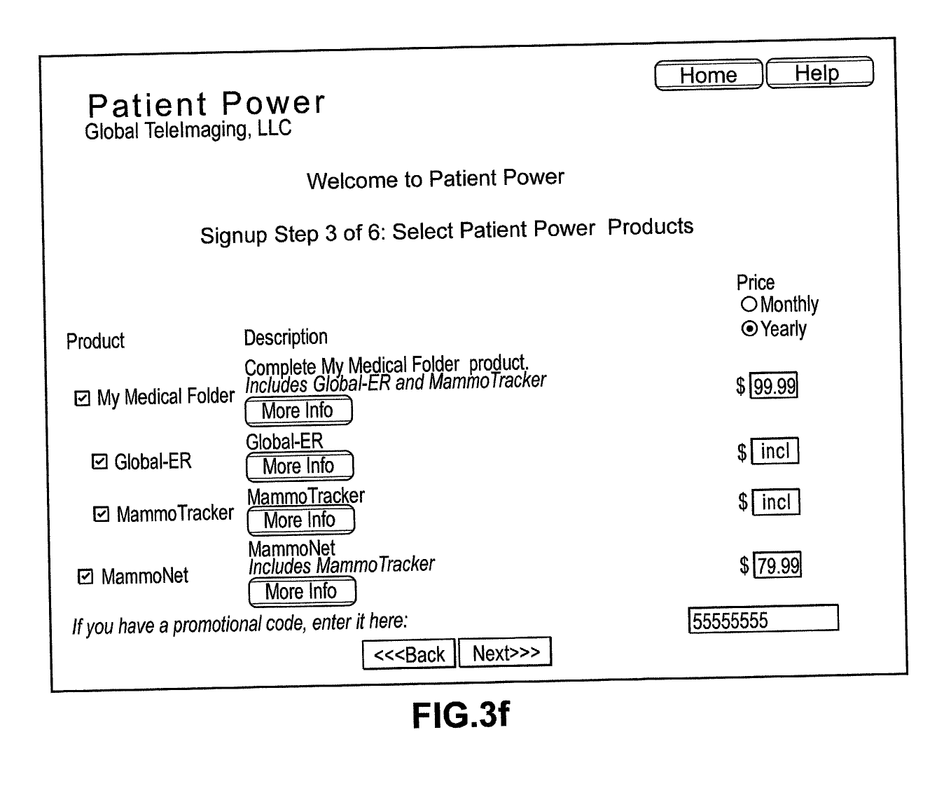

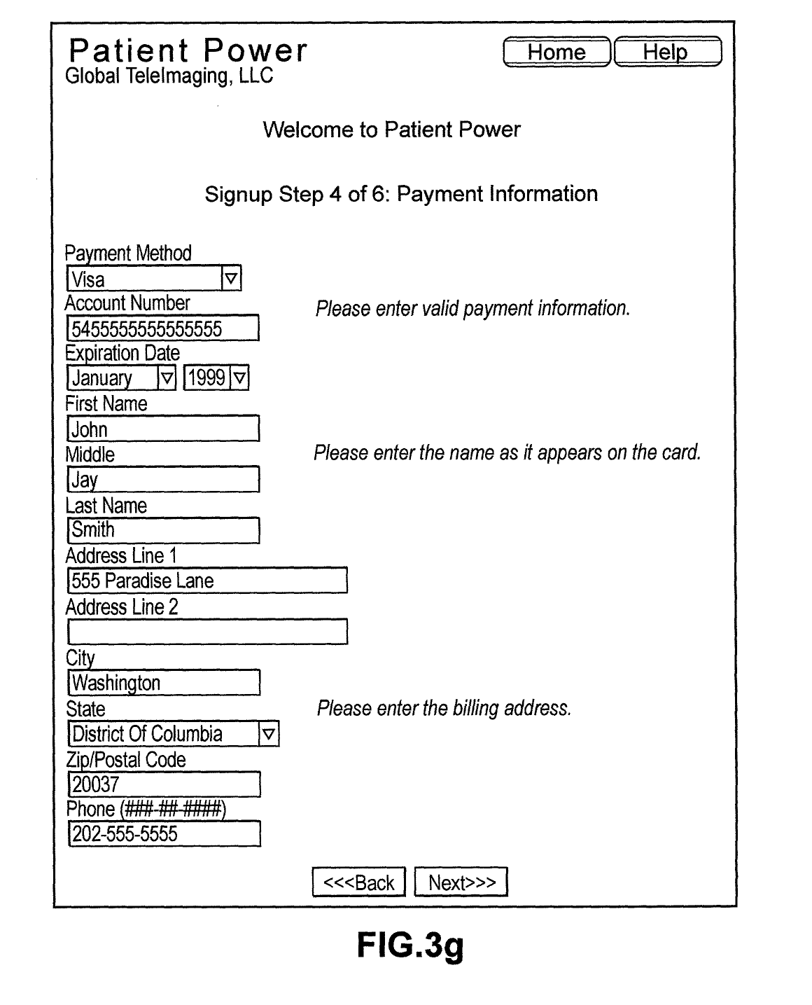

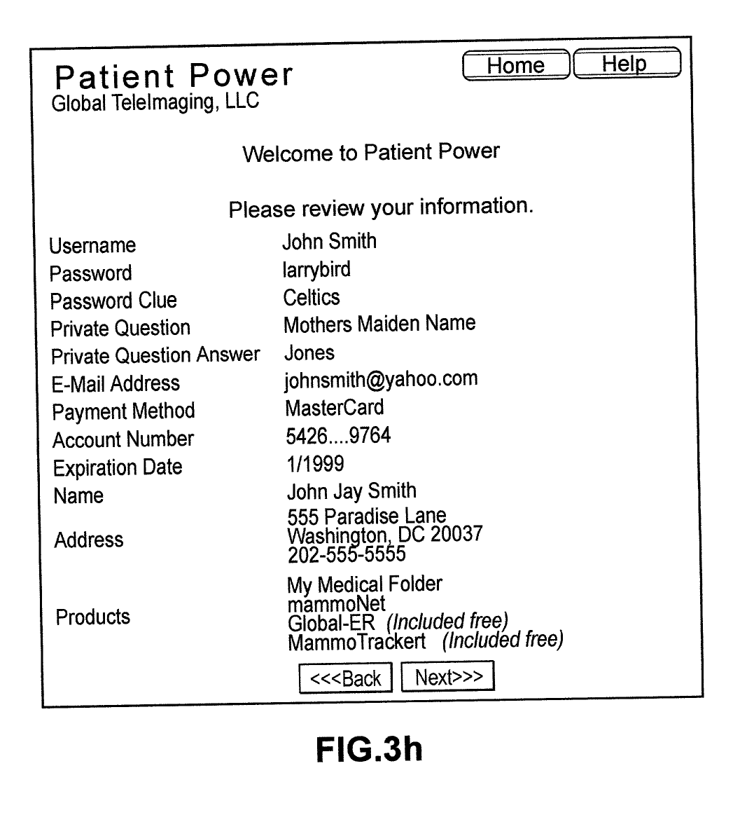

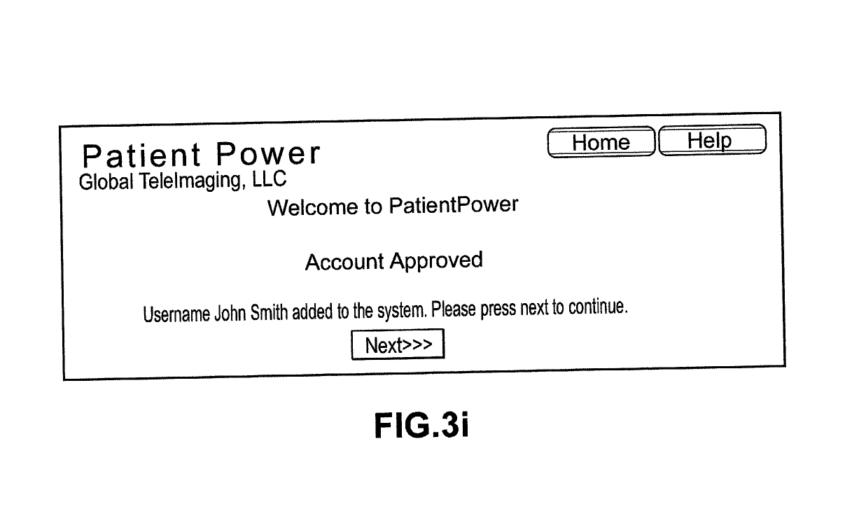

Referring to FIG. 3a, according to the preferred embodiment of the present, a patient first registers with the medical record management service, for example, through the Internet or by facsimile machine. Alternatively, although not shown on FIG. 3a, the patient could also register by calling a telephone call center. In either case, the patient provides general background and contact information, such as name, address, telephone number, social security number, billing information, date of birth, name of primary care physician, and e-mail address. This information is stored in the account database 132. Also at the time of registration, the patient pays any required registration fee.

For facsimile registration, a patient completes a form asking for the required registration information. The form could be completed and transmitted from any location having a facsimile machine. However, most likely, the form is completed at the office 300 of a primary physician or radiologist. A designated representative 302 at the office proofreads the form 304, provides any assistance the patient may need, faxes the form to administrative center 102, and collects the registration fee. Administrative center 102 receives the form, keys the information into a new account in account database 132, and assigns a unique patient identification (UPI) and password to the patient. Administrative center 102 then sends a return facsimile to the office 300 confirming the successful account registration and informing the patient of her account access information (UPI and password).

For online registration, the patient uses an Internet computer workstation 306 to access the website of the present invention. On the home page, as shown in FIG. 2b, the patient clicks on Sign Up button 208 to launch the registration GUI. The registration GUI returns a welcome page (FIG. 3b) followed by a terms and conditions page (FIGS. 3c). Upon acceptance of the terms and conditions, the registration GUI prompts the patient for a username, social security number (or if the patient so desires, a surrogate series of computer generated numbers and letters), and date of birth (FIG. 3d); a password, password questions, and e-mail address (FIG. 3e); product selections and a promotional code, if any (FIG. 3f); and, payment information (FIG. 3g). Having received all registration information, the registration GUI then asks the patient to review and confirm the entered information (FIG. 3h) and returns a confirmation that the account is approved (FIG. 3i). The registration GUI assesses the registration fee in accordance with the provided payment information, e.g., charges a credit card. In addition to confirming account approval as shown in FIG. 3i, the registration GUI provisioned in administrative center 102 sends a separate communication, e.g., e-mail, informing the patient of her UPI and password.

As an alternative to completing forms, entering data through the Internet, and calling a telephone call center, the present invention can obtain patient demographic data directly from existing databases, such as the Radiology Information System (RIS) or Hospital Information System (HIS), depending on the systems and interfaces in operation at a particular site.

The present invention provides the patient with ownership and control of her own medical record, controlling access to the medical records using UPIs, passwords, and physician access codes. Thus, before opening a medical record, a patient must log in and provide the UPI and password. A physician uses a separate access code (and the UPI), which allows access to a patient's record when the patient has granted permission for viewing and/or updating. In the preferred embodiment of the present invention, a UPI is an 18-digit number unique to every patient, which is used to associate all records of a patient. The first nine digits of the UPI are the patient's social security number, or if the patient desires not to use her social security number, are a series of nine random numbers and letters. The tenth digit indicates whether the preceding nine are the patient's social security number or are random, e.g., a “1” would indicate a social security number and a “0” would indicate random numbers and letters. The remaining eight digits are the patient's date of birth, e.g., a four digit year, a two digit month, and a two digit day. With this unique tag, the present invention easily matches and gathers a patient's records across different proprietary patient information systems, such as non-affiliated clinics and hospitals.

2) Medical Data Entry

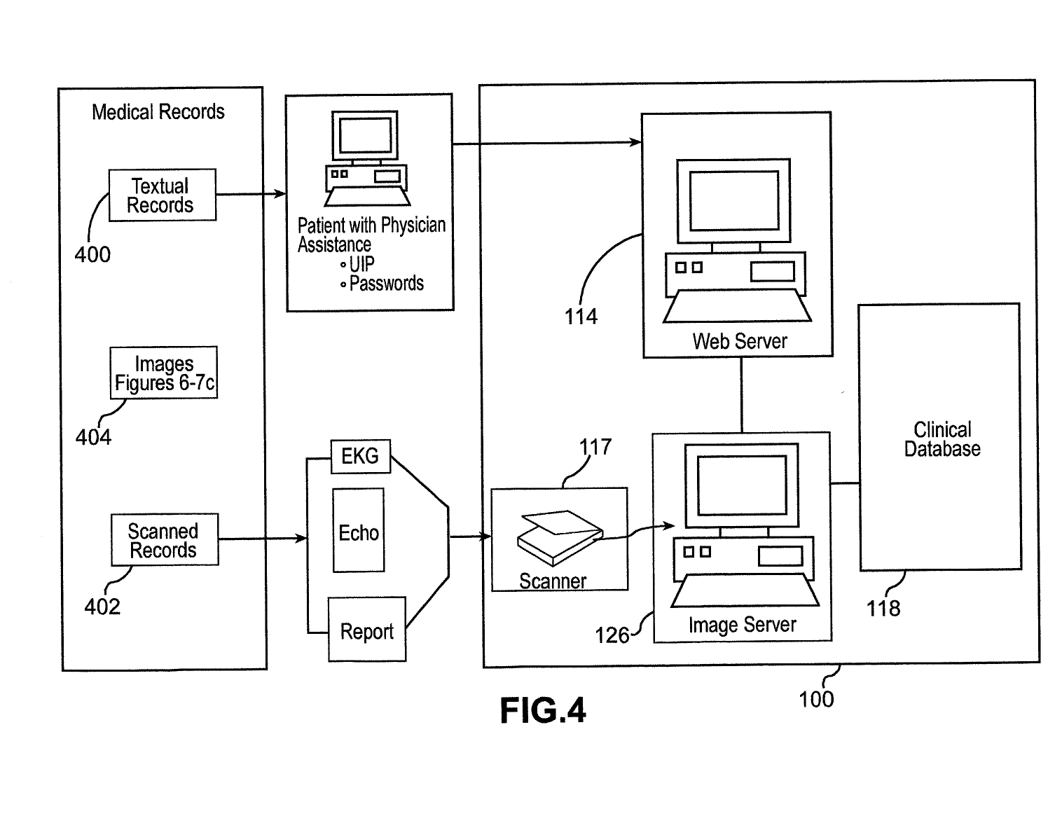

Referring to FIG. 4, the method by which medical records are entered into the patient medical record service depends on the format of the medical record. The three different formats include textual records 400, scanned records 402, and medical images 404.

a) Textual Records

Textual records 400 are simply keyed into the website GUIs and stored in clinical database 118. If a patient registers for the service at a physician's office, the patient and either a staff associate or a doctor work together to enter the pertinent data into My Medical Folder at that time. If the patient registers from home or another Internet workstation outside of the physician's office, the patient enters the data in the appropriate fields and reviews the entered clinical data with her primary physician during the next office visit and medical record consultation.

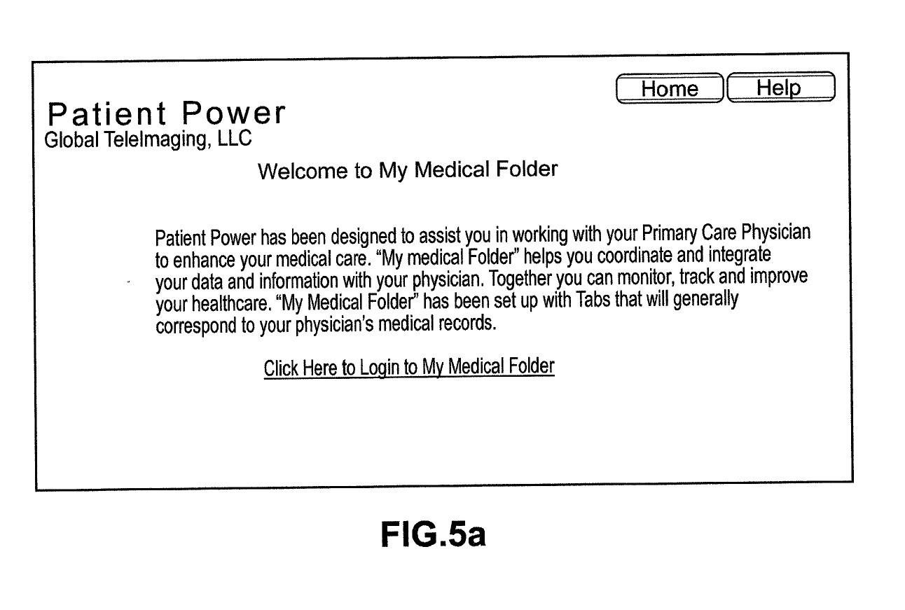

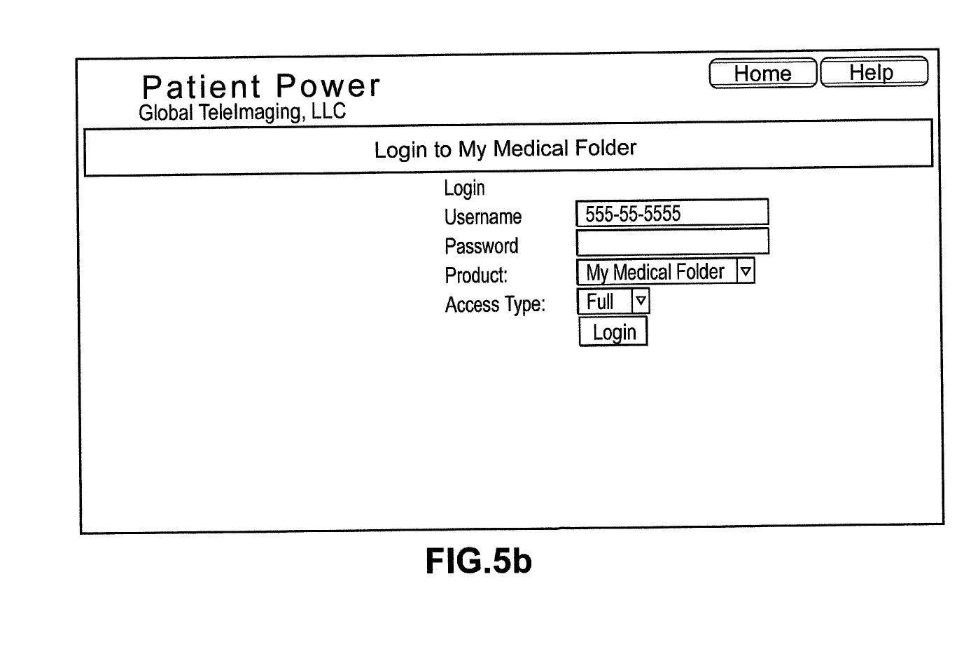

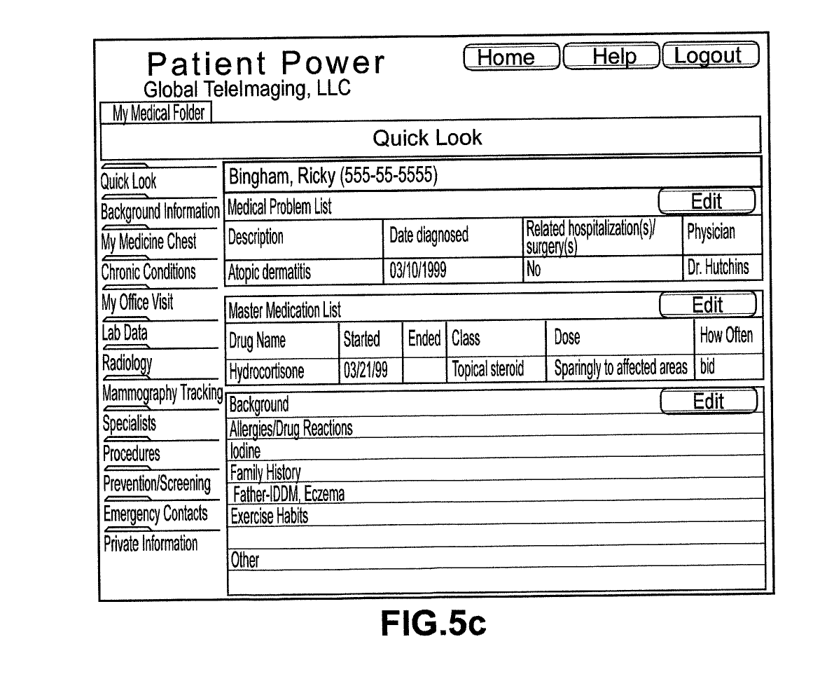

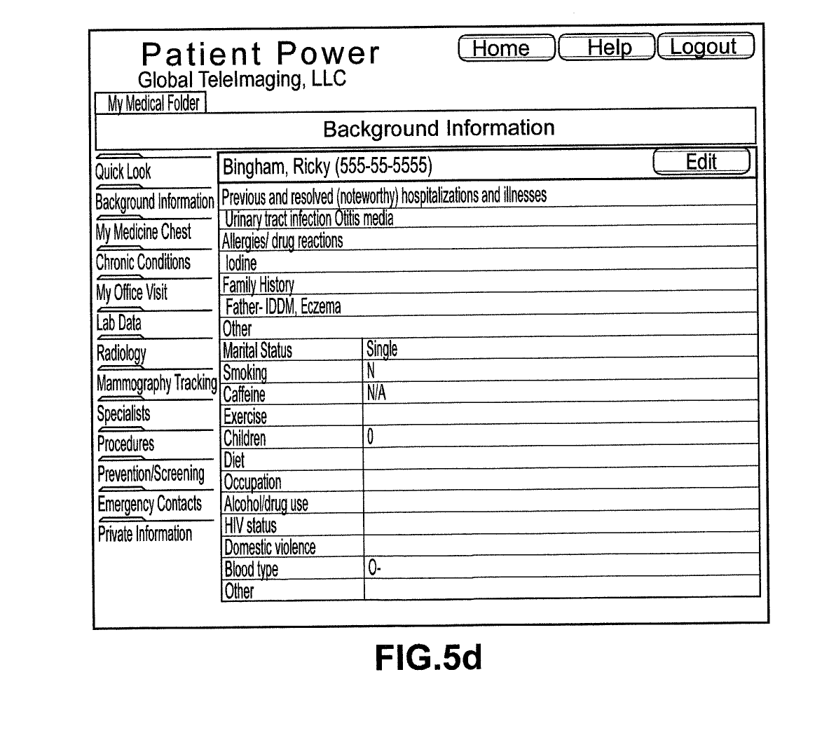

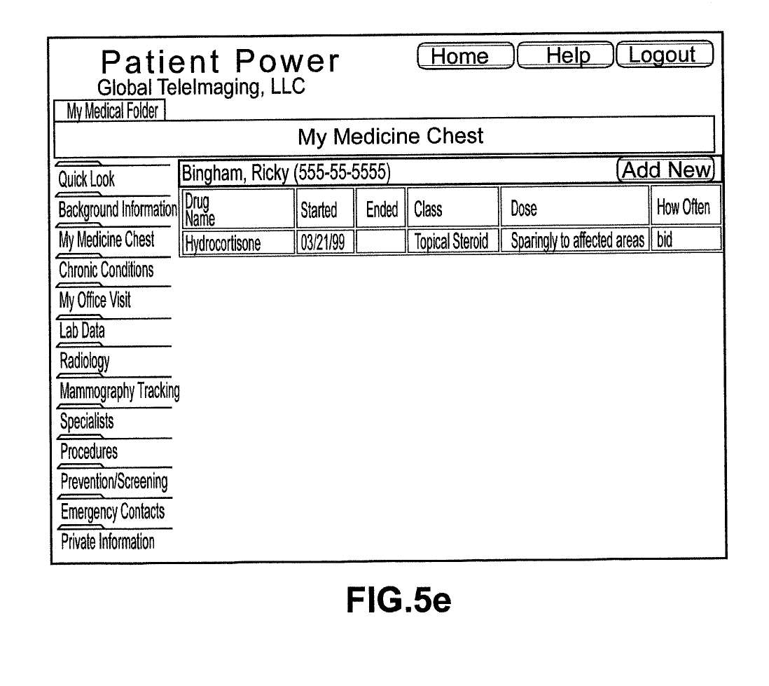

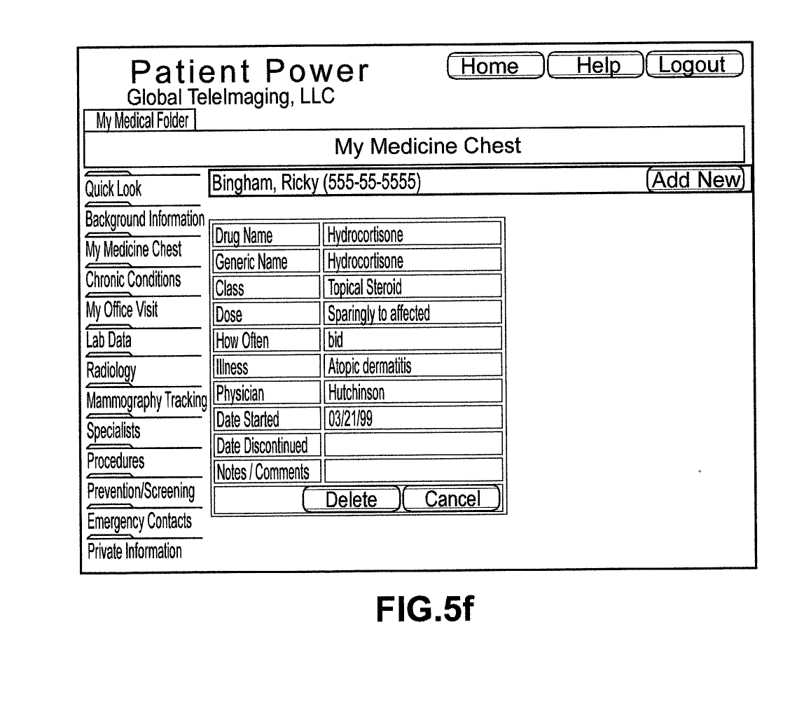

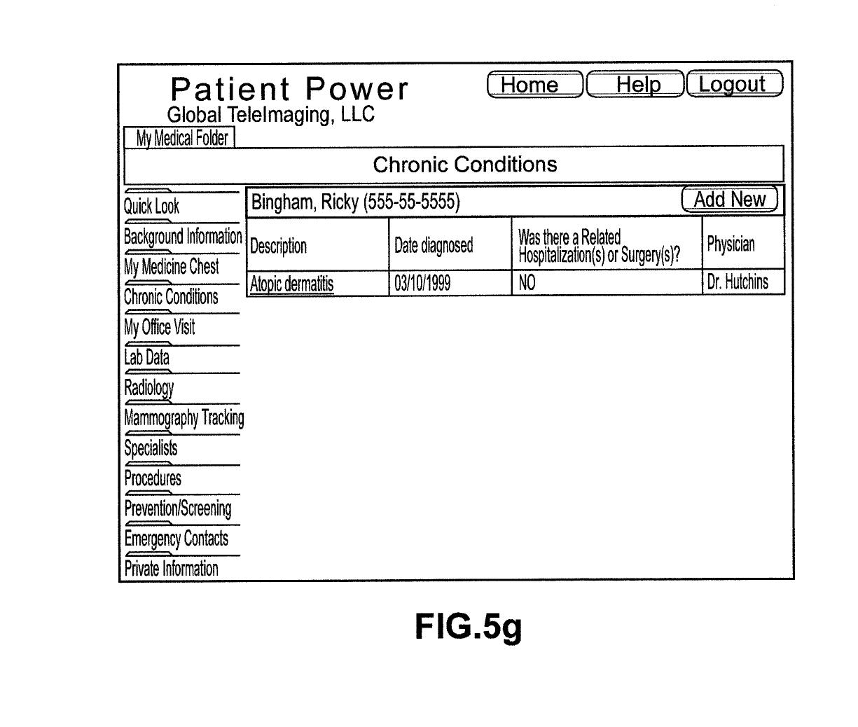

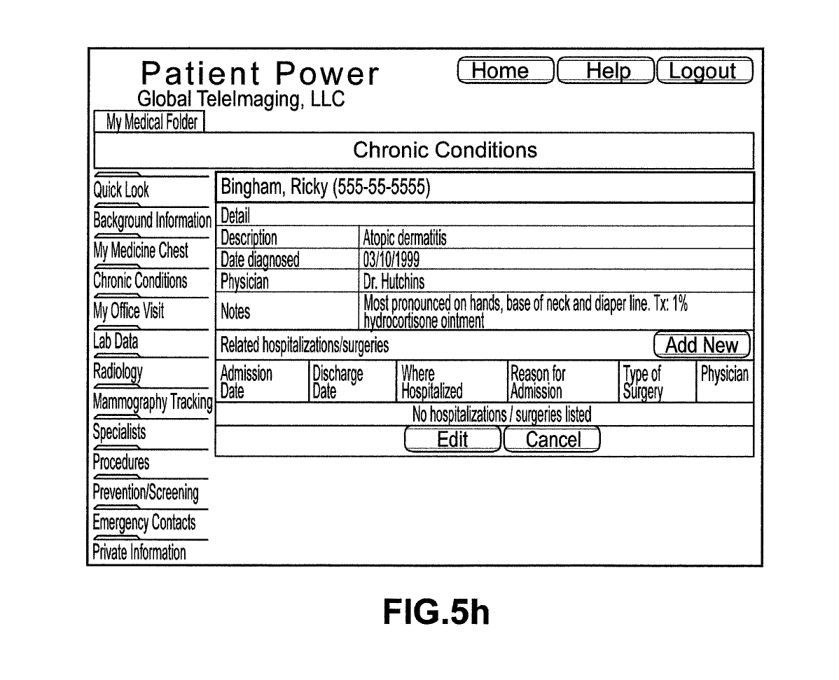

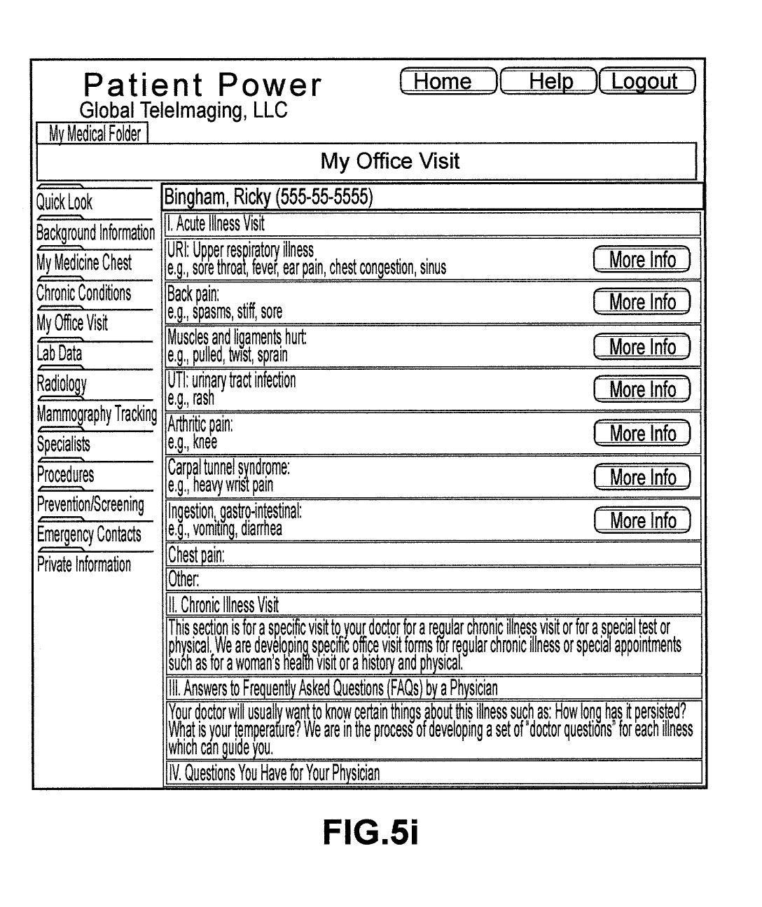

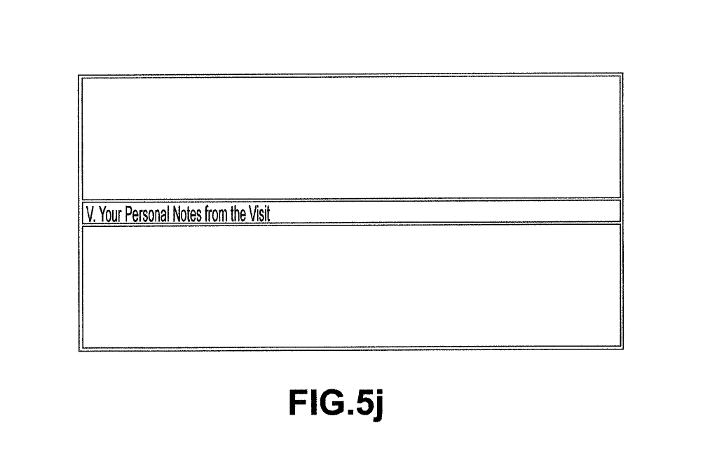

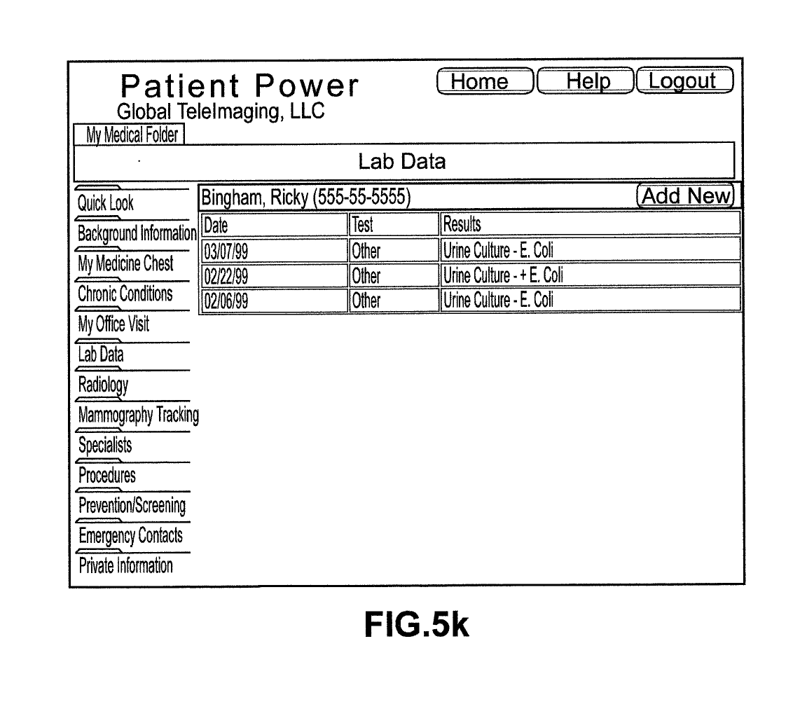

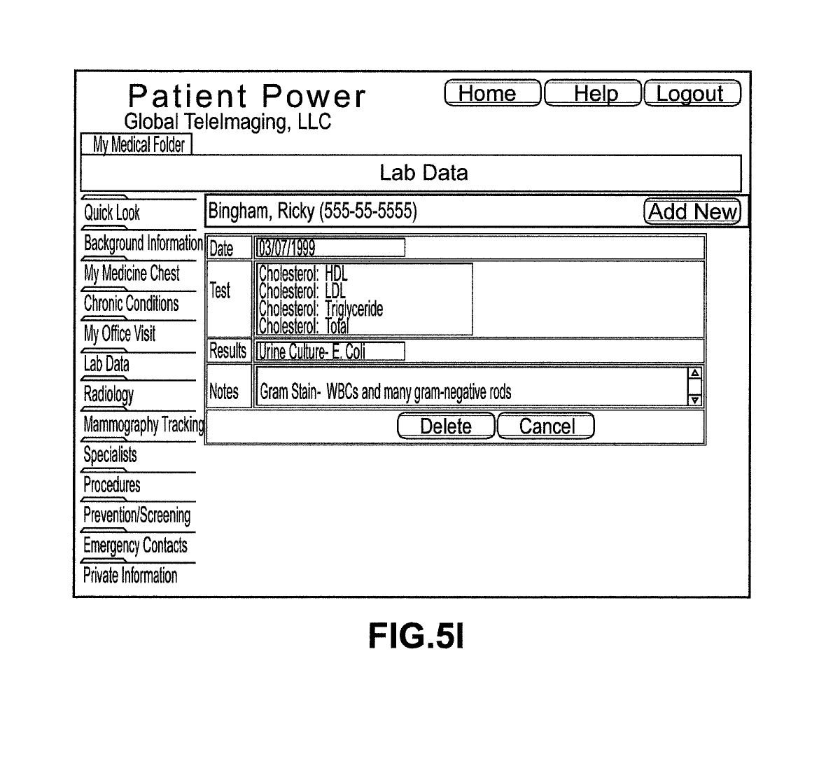

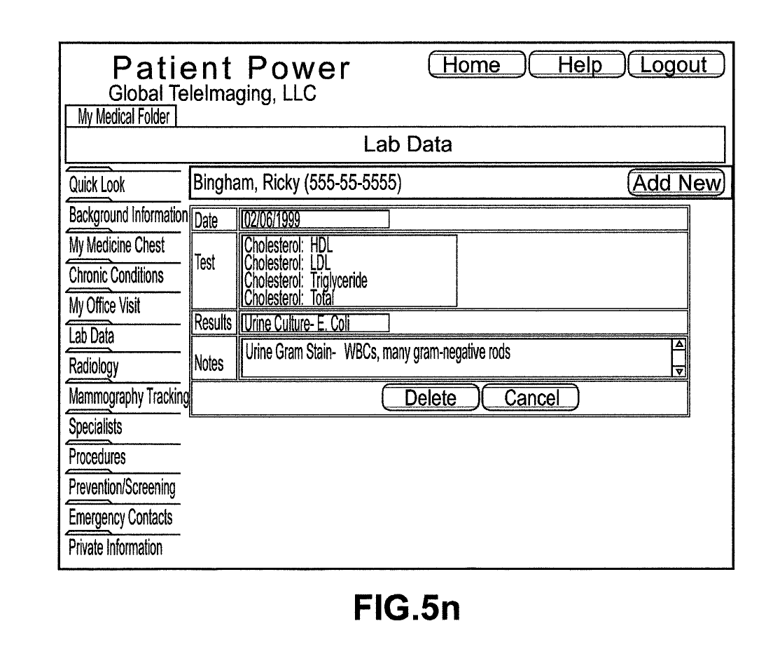

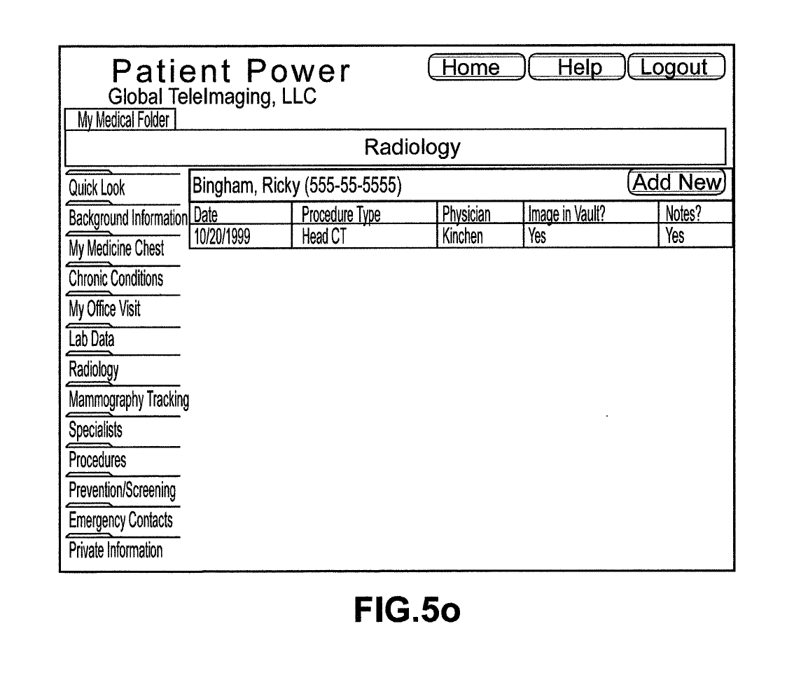

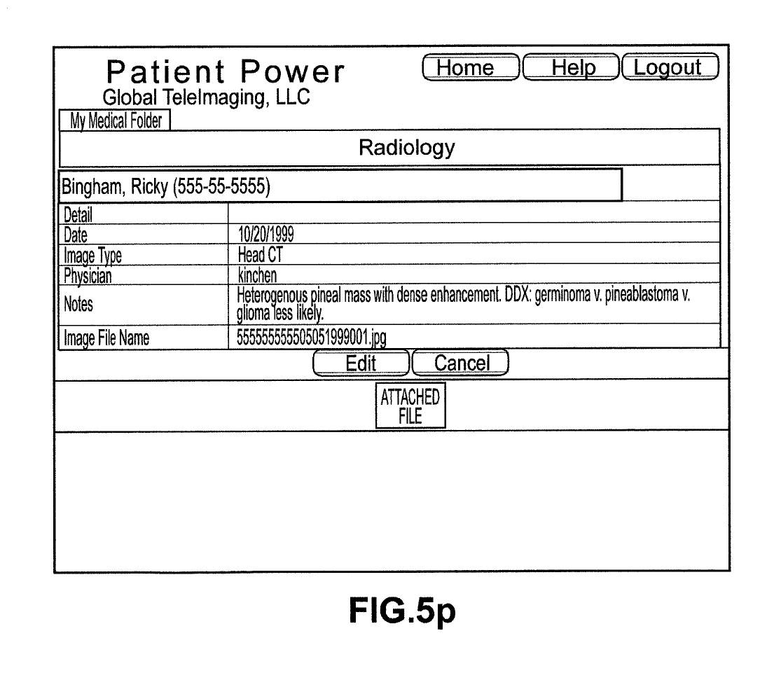

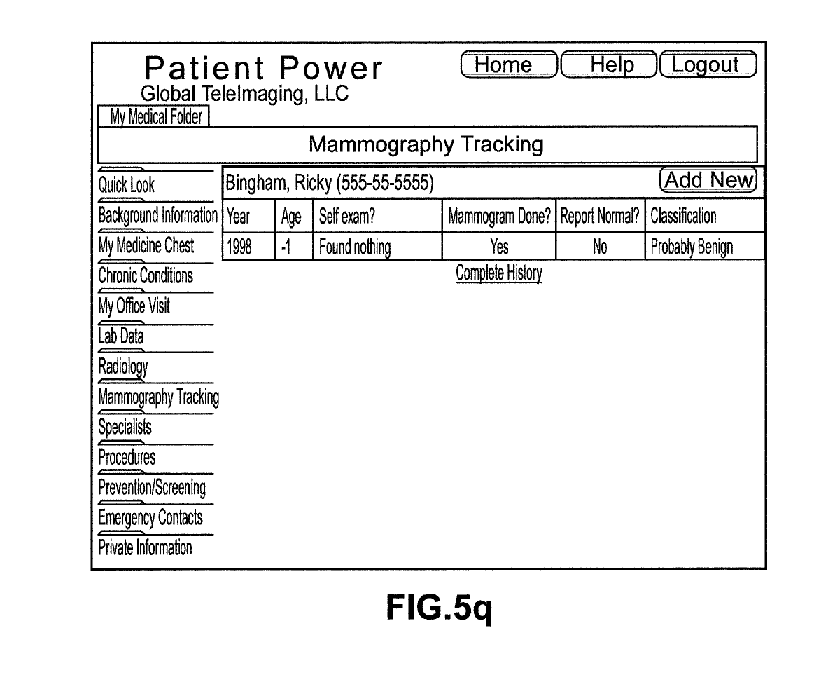

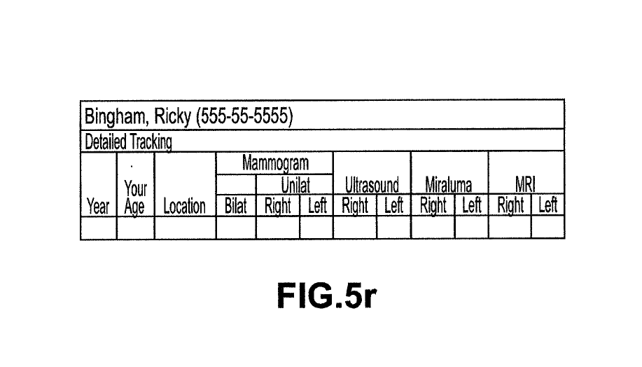

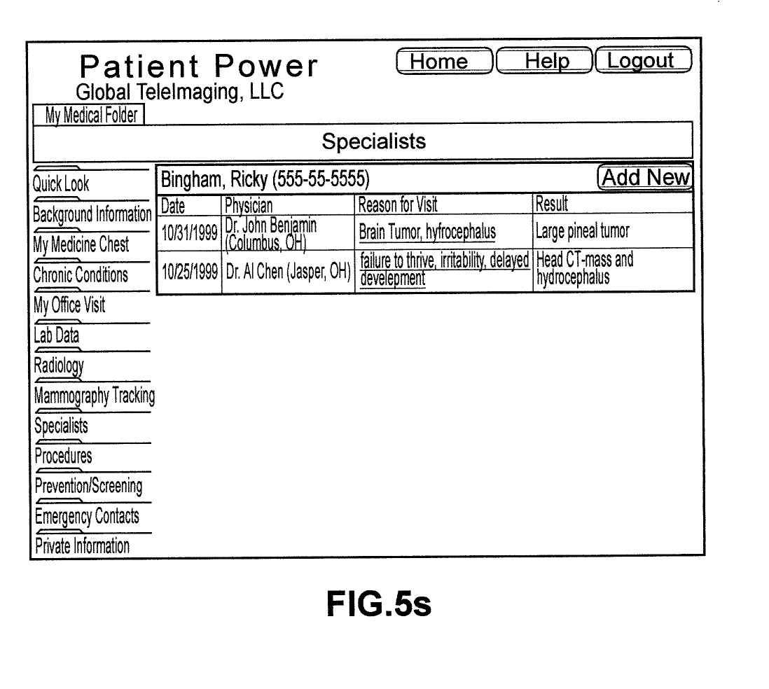

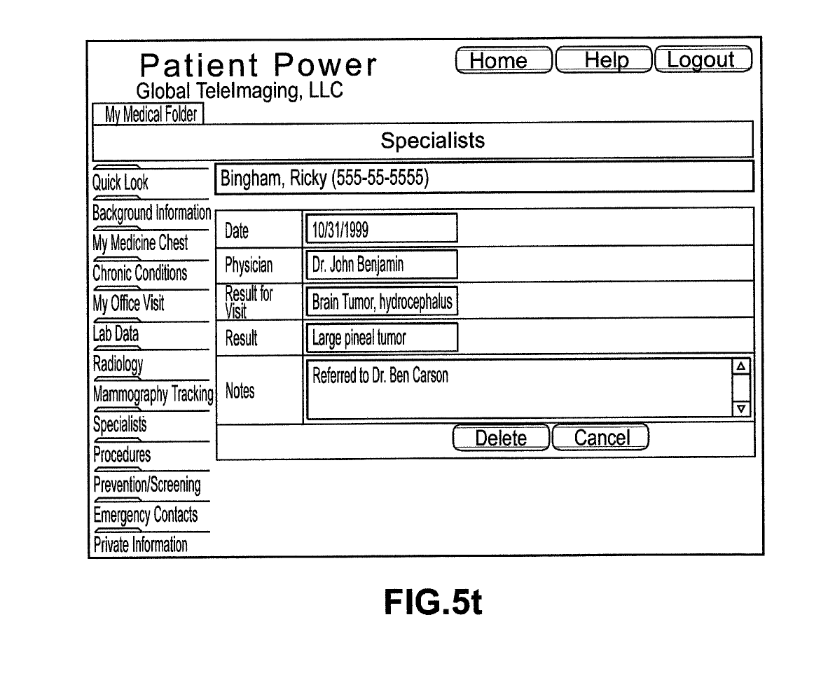

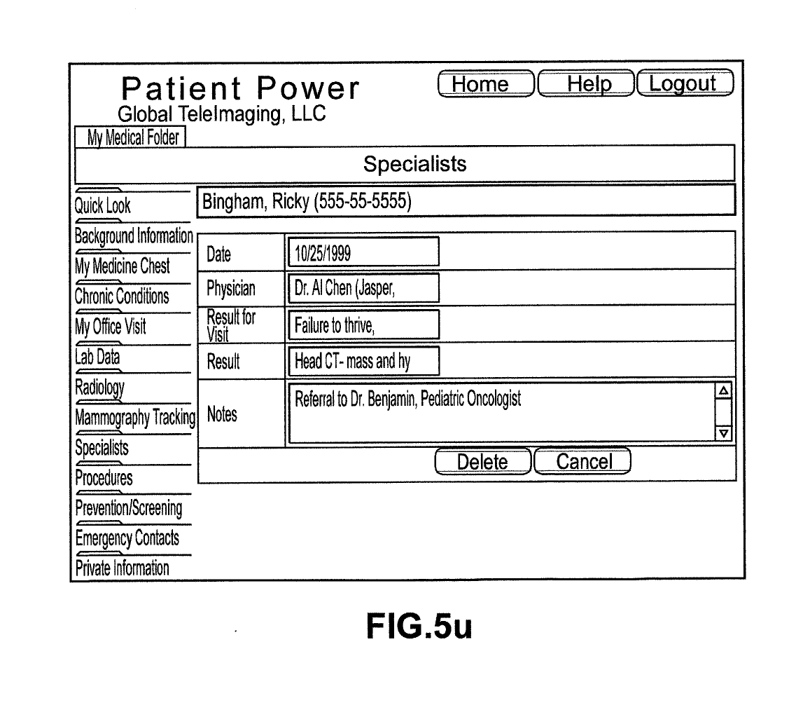

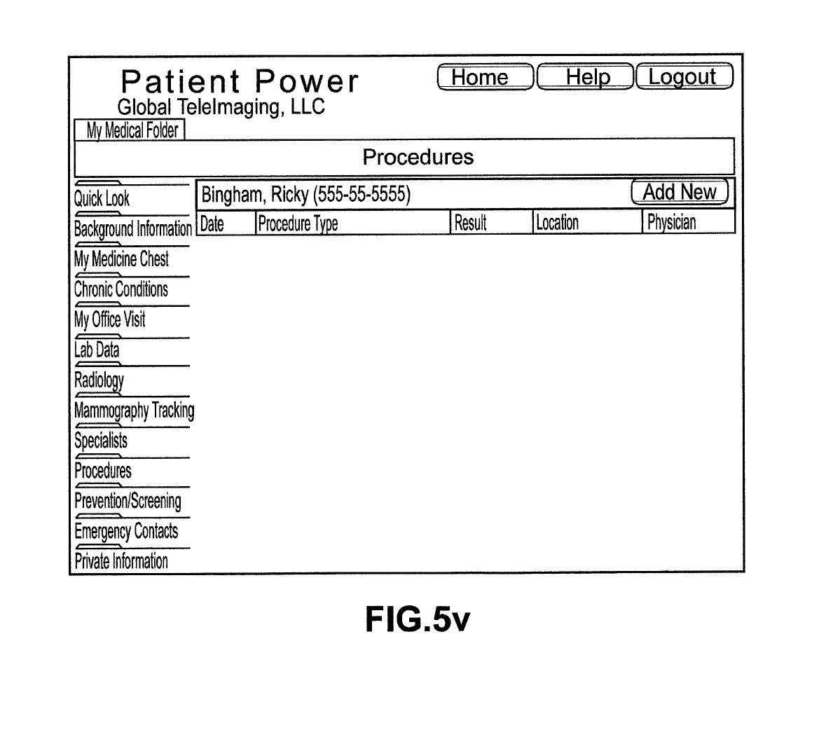

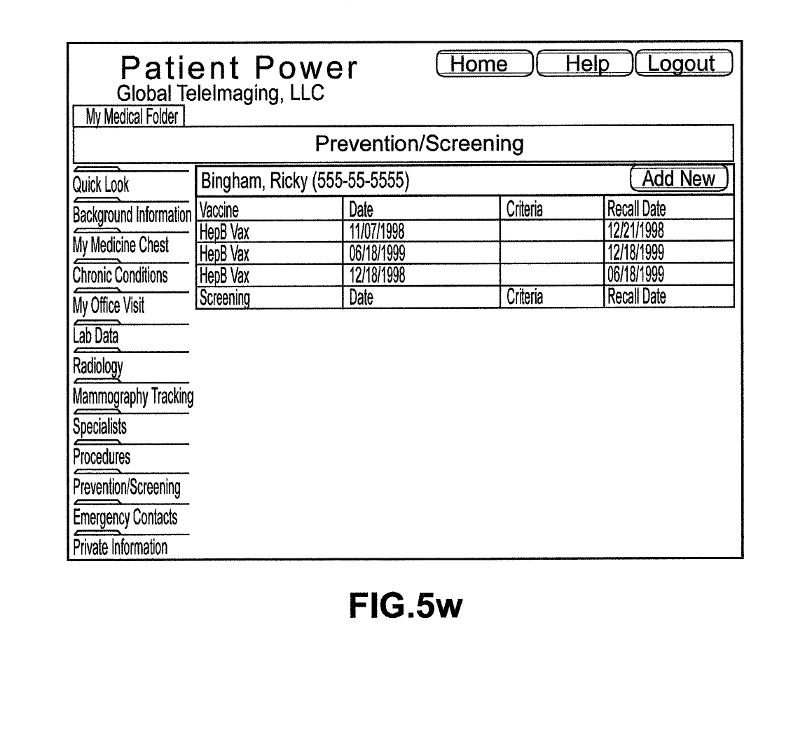

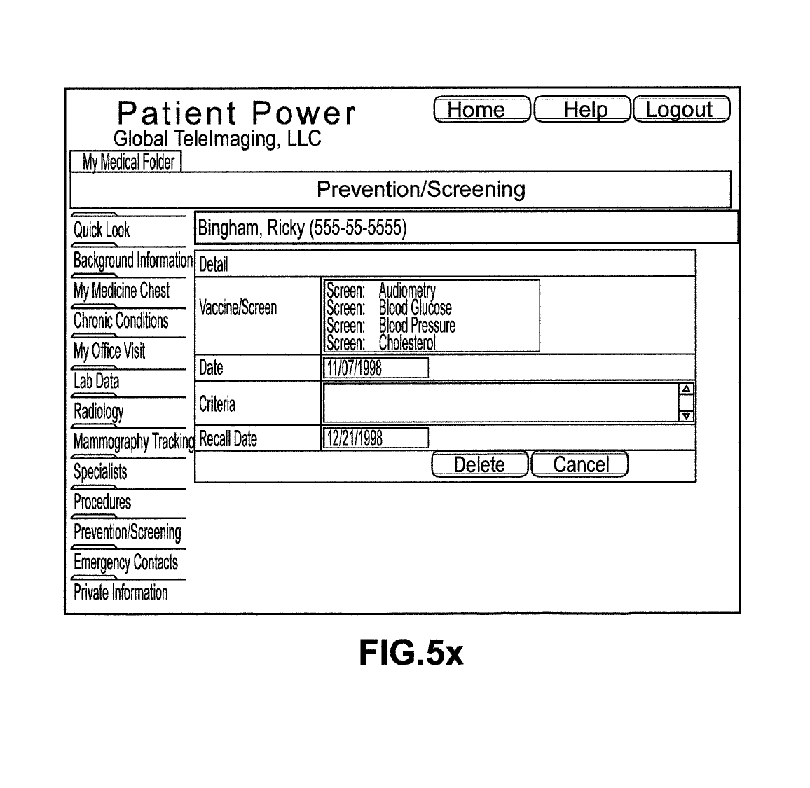

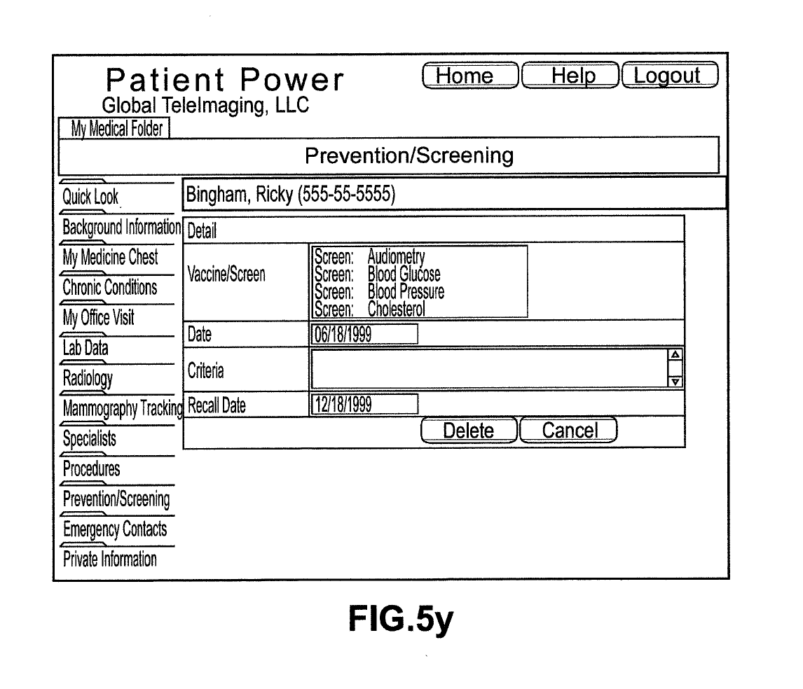

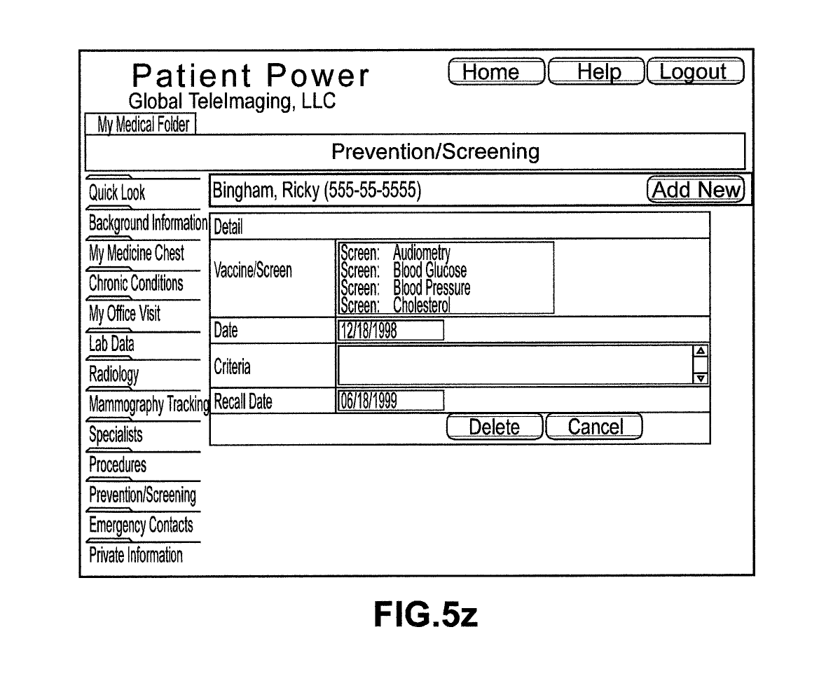

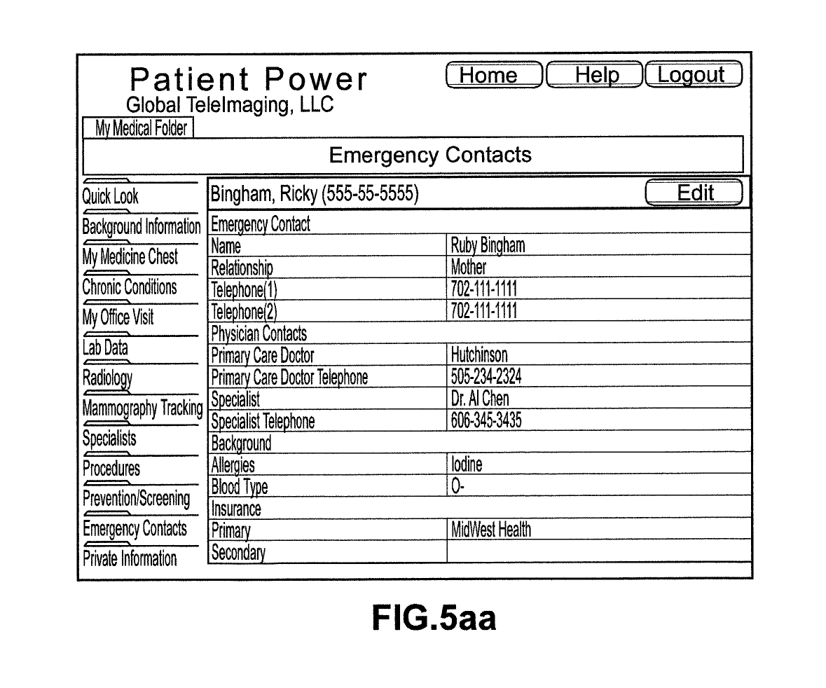

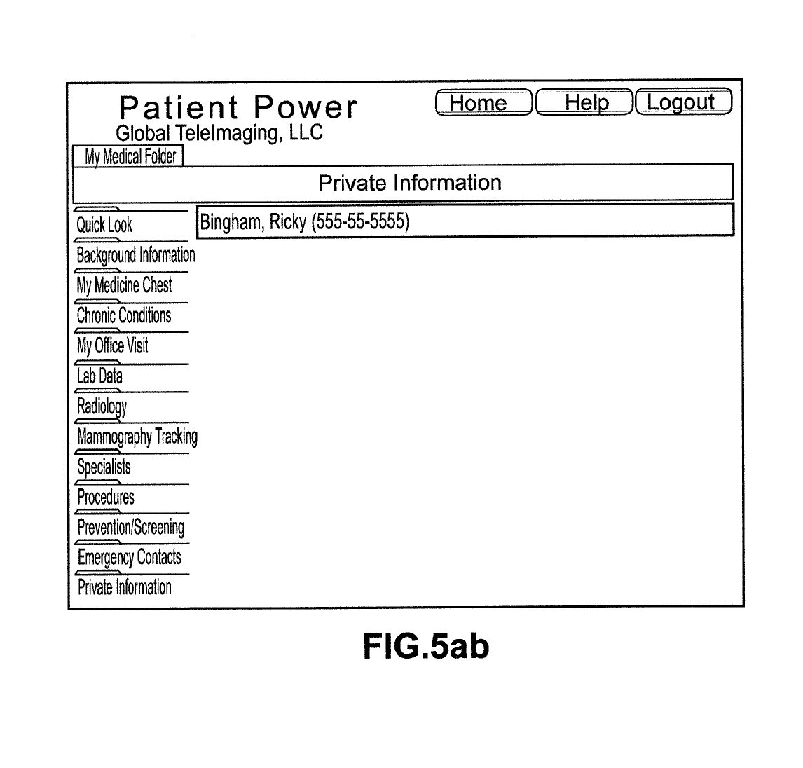

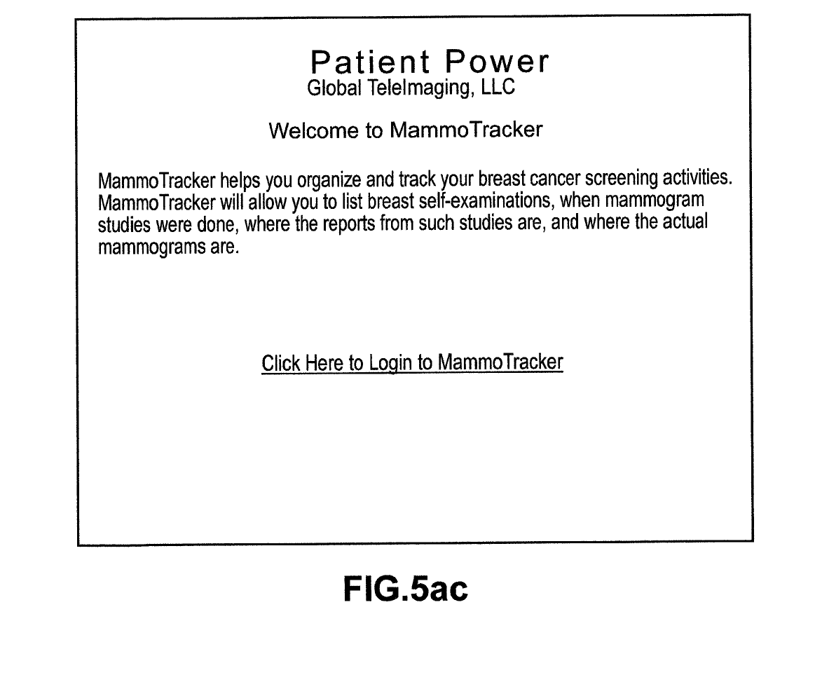

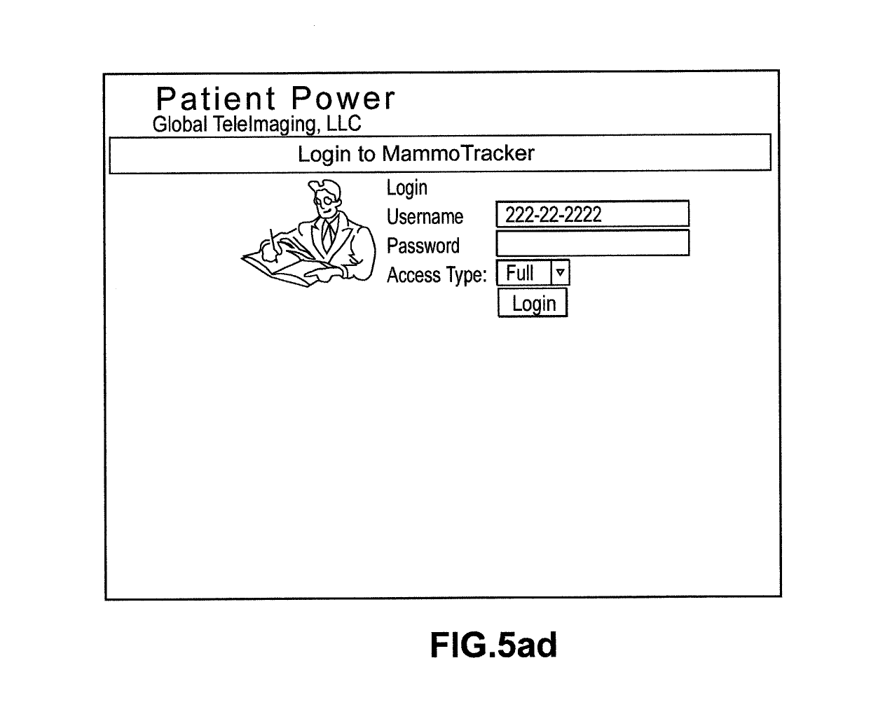

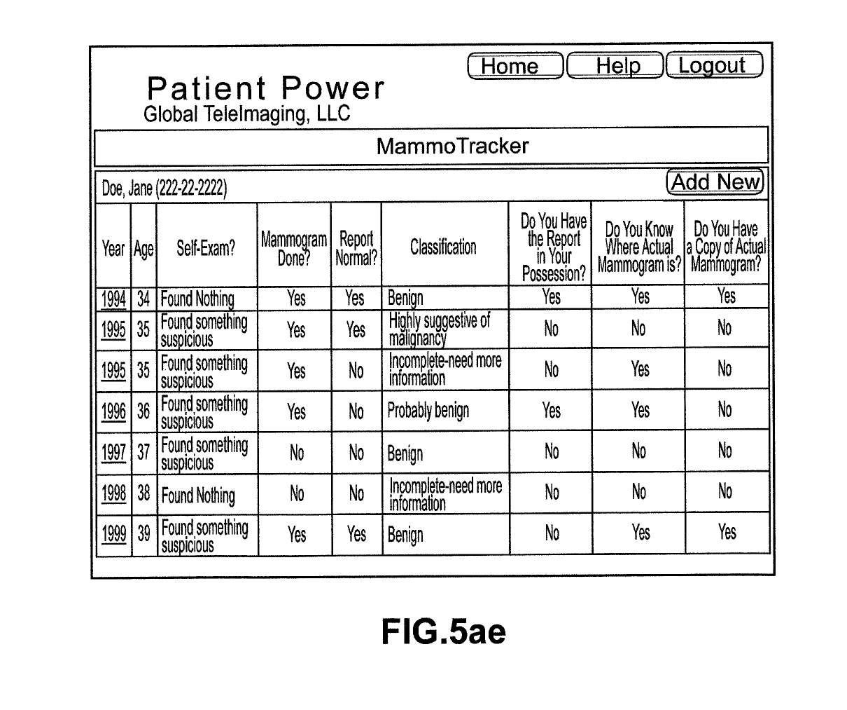

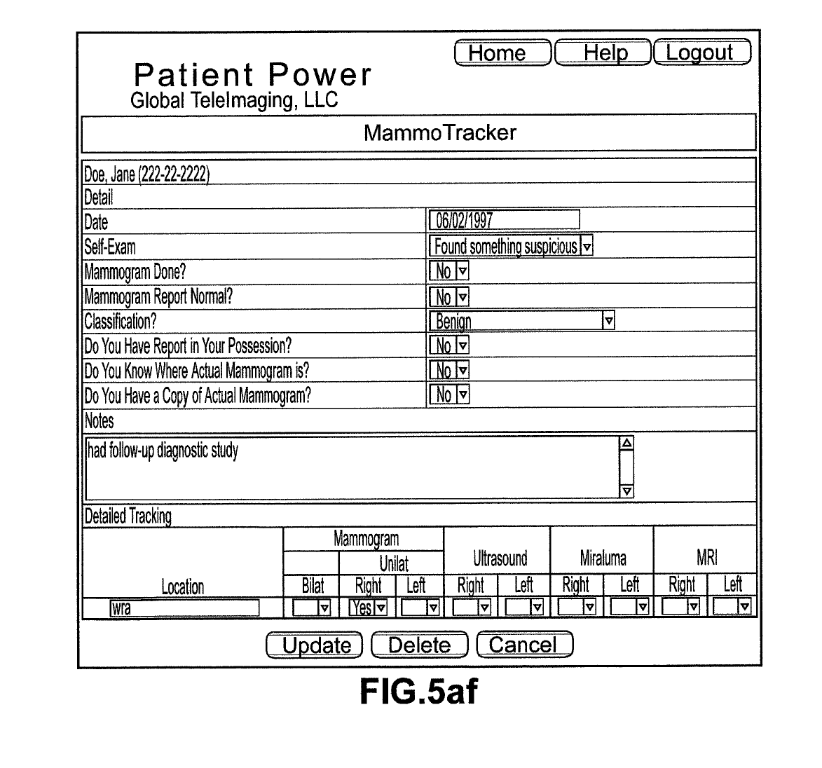

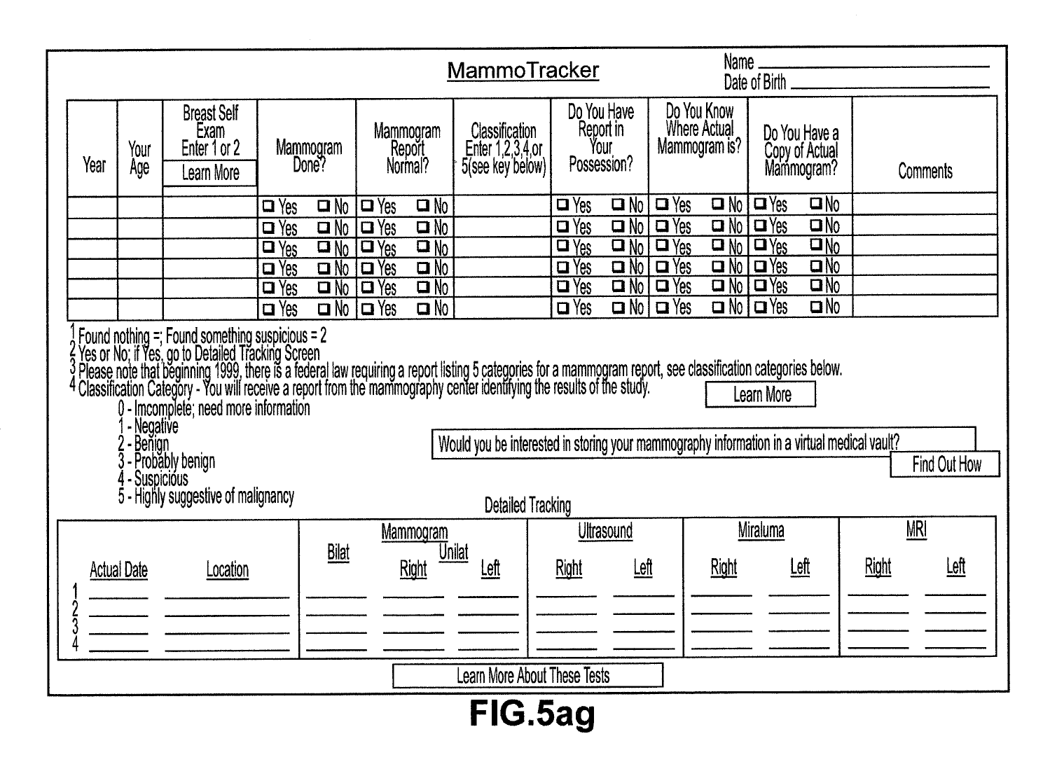

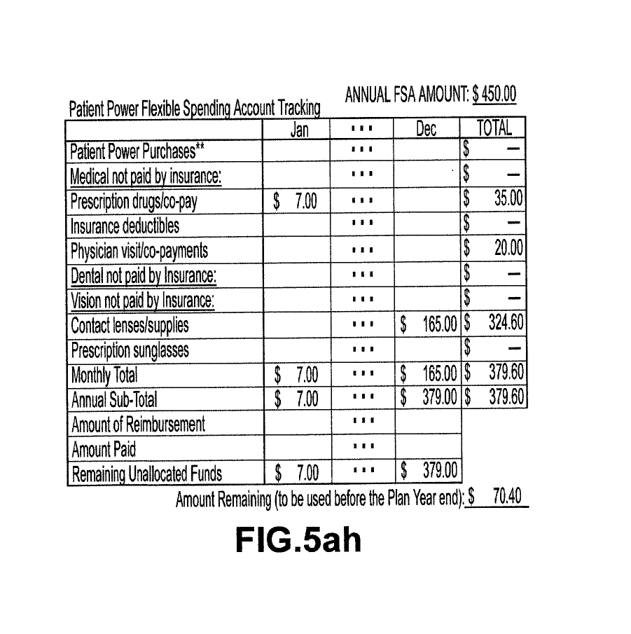

FIGS. 5a-5ab illustrate the various website GUIs a patient navigates through to enter medical data. FIG. 5a is the welcome page for My Medical Folder. FIG. 5b is the login page required to gain access to the medical record. Once access is accepted into My Medical Folder, the patient or physician can access and enter data into several different components of My Medical Folder, including Quick Look, Background Information, My Medicine Chest, Chronic Conditions, My Office Visit, Lab Data, Radiology, Mammography Tracking, Specialists, Procedures, Prevention/Screening, Emergency Contacts, and Private Information. While browsing the website of the present invention and entering data, the patient or physician can access these components at any time by clicking on the structured tabs displayed on every screen. Each screen resembles a form from a conventional medical chart and includes explanatory remarks and instructions.

Immediately after login, as shown in FIG. 5c, the GUI presents the Quick Look record, a summary sheet that lists the patient's important medical information and serves as a valuable overview for the physician. In accordance with the description for each data field, the patient or physician enters the data. After completing the Quick Look record, the patient and/or physician clicks on each tab and enters the appropriate data in each field. The Background Information (FIG. 5d), My Medicine Chest (FIGS. 5e and 5f), and Chronic Conditions (FIGS. 5g and 5h) records are summaries of a patient's medical history and current and historic medication information. The My Office Visit record (FIG. 5i and 5j) is a list of office visit encounter forms and diagnostic illness assistance. The Lab Data (FIGS. 5k-5n) and Procedures (FIG. 5v) records are summaries of tracking for results of laboratory tests and diagnostic procedures. The Radiology record (FIGS. 5o and 5p) is a summary of radiological assessments, notes, and reports, with links to the actual images (discussed below). The Mammography Tracking record (FIGS. 5q and 5r) is listing of a patient's mammography history, which is linked to MammoTracker and can be linked to MammoNet if the patient purchases the product. The Specialists record (FIGS. 5t-5u) is a list of specialists and other consulting physicians, including scanned specialist reports when appropriate. The Prevention/Screening record (FIGS. 5w-5z) is a summary of tracking and scheduling of preventative health topics, such as cancer screening. The Emergency Contacts record (FIG. 5aa) contains information a patient wishes to make available to a health care facility or to ambulance or emergency personnel in case of an emergency. The Private Information record (FIG. 5ab) includes information that only the patient can access, and does not allow access by physicians who are authorized to view the remaining records. In addition, the Private Information record includes software applications that track health care related concerns such as flexible spending accounts, copayment summaries, and tax summaries. FIG. 5ah illustrates a page of a software application that tracks a patient's flexible spending account.

For the My Office Visit record (FIG. 5i and 5j), a patient would not complete the record immediately after service registration, but would instead enter data in the record prior to an office visit. The My Office Visit record prompts the patient for information that will generally be requested by the patient's physician at the time of the visit, e.g., information concerning an illness for which the patient is visiting the physician. The My Office Visit record also prompts the patient to perform certain actions, such as taking her temperature or carefully describing symptoms. In addition, the My Office Visit record includes forms designed to facilitate scheduled and periodic office visits for chronic illnesses, such as diabetes or cardiovascular diseases. The forms educate the patient in advance about the condition, enable the patient to have more informed interactions with the physician, and allow the patient to be more involved in understanding and complying with the physician's choice of treatment protocols.

In addition to manually entering textual records 400, a further preferred embodiment of the present invention acquires textual data directly from existing databases, e.g., HIS and RIS. In this manner, web server 114 interfaces directly with a database and downloads the information corresponding to the data fields of My Medical Folder.

For MammoTracker, a patient or physician enters data in a manner similar to My Medical Folder, but only for details concerning breast cancer screening. After clicking on the MammoTracker button 216 as shown in FIG. 2b, the patient or physician logs in and enters data in the various data fields, as shown in FIGS. 5ac through 5ag.

b) Scanned Documents

In contrast to textual records 400, scanned documents 402 require a somewhat more involved method of data entry, as shown in FIG. 4. Scanned records 402 include such documents as EKGs, laboratory test results (reports), and echocardiograms, which generally cannot be easily summarized in textual form and for which a picture is most appropriate. Thus, to have a more useful medical record, these types of documents must be scanned and stored as image files in clinical database 118 under the appropriate tabbed records in My Medical Folder. The image files do not have to be of diagnostic-quality, rather only of legible quality suitable for clinical purposes.

If the original record is on paper, either the original or a copy is forwarded to operations center 100, where it is logged in, matched to the patient's account, and scanned into clinical database 118 using scanner 117 and image server 126. The type of electronic file into which the record is scanned depends upon the standard required by clinical database 118, e.g., JPEG or PDF files. Alternately, the original paper record is faxed and received by image server 126 for storage in clinical database 118 as an electronic facsimile file. As another option, if the original record is already an electronic file, the record can be e-mailed directly to web server 114 of operations center 100, and stored in clinical database 118 by image server 126.

c) Medical Images

Because of the need for diagnostic quality, medical images 404 require the most complex method for data entry. Medical images 404 are any visual medium that must be of diagnostic-quality to be clinically useful, e.g., MRIs, CTs, and mammograms. The methods for entering medical images fall under two principal categories: non-mammography images and mammography images. Preferably, a patient uses My Medical Folder to manage non-mammography images and uses MammoNet to manage mammography images. The separate methods for storing mammography studies are necessary to accommodate specialized needs, such as large image files and computer-aided detection.

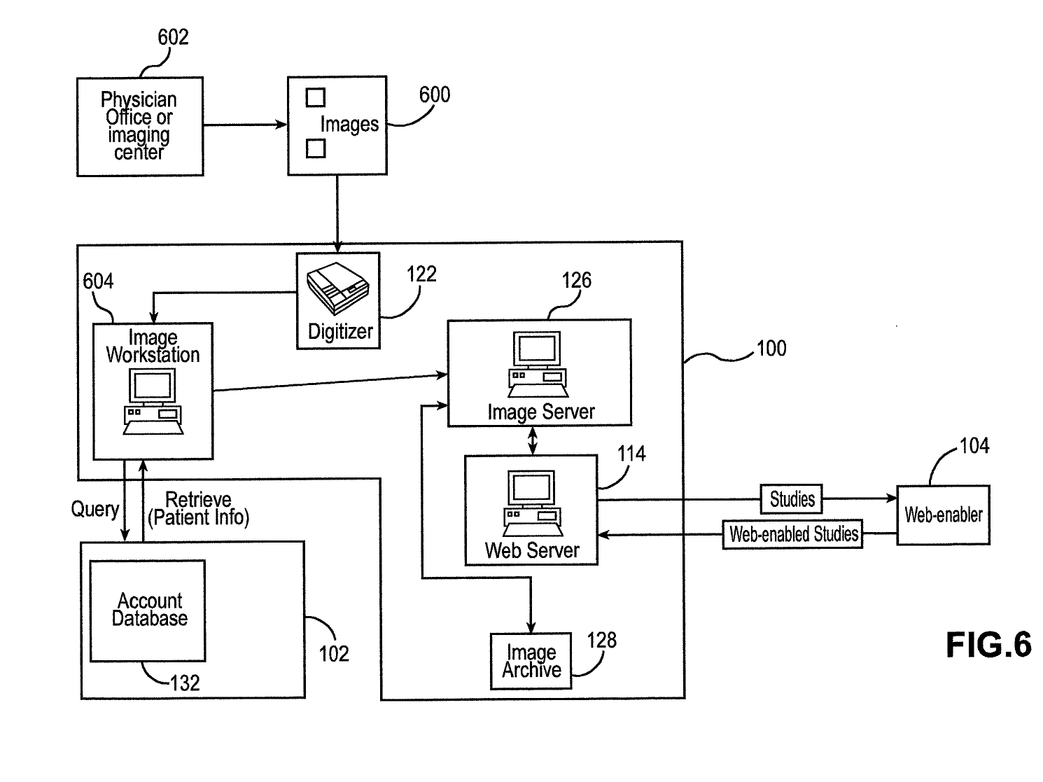

FIG. 6 illustrates the method for storing non-mammography medical images into a patient medical record. First, a patient retrieves (borrows) the medical images 600 from the imaging center or physician's office 602 that owns the records. The patient then delivers the medical images 600 to operations center 100, where the studies are logged in. A technician at operations center 100 scans medical images 600, which are then displayed on image workstation 604, preferably in a DICOM (Digital Imaging and Communications in Medicine) format. The technician then tags the digitized medical images with the patient's name and UPI. With the patient preregistered, image workstation 604 queries account database 132 using the patient's name and UPI to retrieve the information necessary for completing bills.

The technician forwards the digitized images from image workstation 604 to image server 126. Image server 126 sends the digitized images through web server 114 to web-enabler 104 to be web-enabled and, optionally, to be stored in a short-term cache of the web-enabler 104, e.g., a 0-30 day cache. Web-enabler 104 is a web file management service, such as Amicas™ of Massachusetts. Image server 126 is provisioned with cooperative software, e.g., Amicas software, to communicate with web-enabler 104. Web-enabler 104 web-enables the files by, among other things, compressing the files and indexing them for subsequent accessing. After web-enabling the files, web-enabler 104 sends them back to image server 126 through web server 114 for storage in an intermediate cache of image archive 128. With files in web-enabled form, an authorized user, such as a patient or physician, can access the digitized images through My Medical Folder.

In a preferred embodiment, as a backup of the web-enabled intermediate cache, before the digitized image files are forwarded to web-enabler 104, a copy of the raw, uncompressed data is stored in the long-term cache of image archive 128. Therefore, if the web-enabled files in the intermediate cache of image archive 128 are somehow lost or unavailable, the raw data can be retrieved from the long term cache, resent to web-enabler 104, returned, and made available again to the patient or physician. As additional protection, image server 126 can also store the digitized image files in its short-term cache.

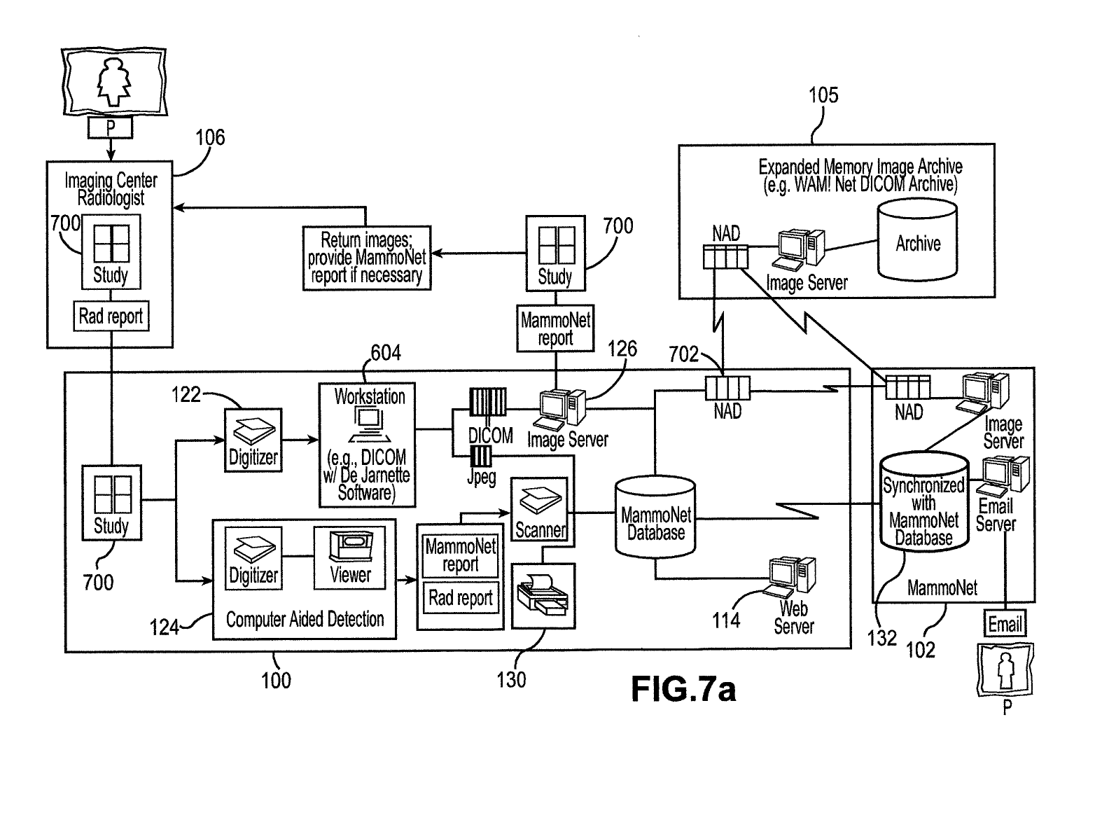

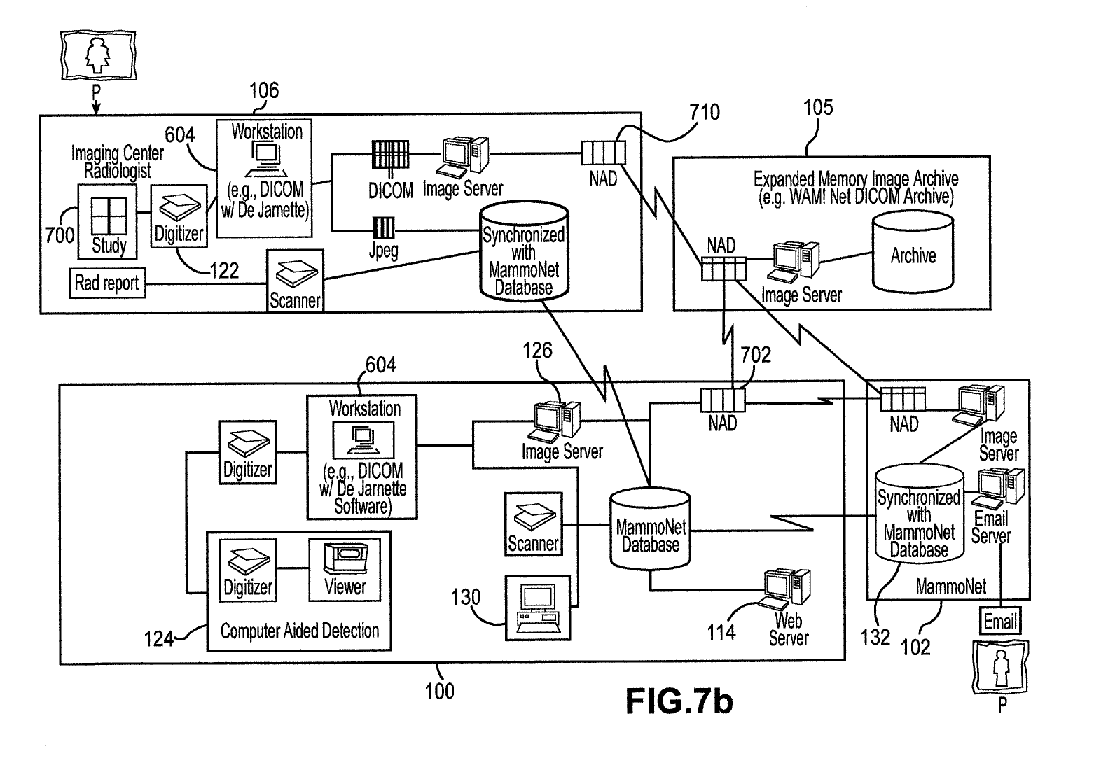

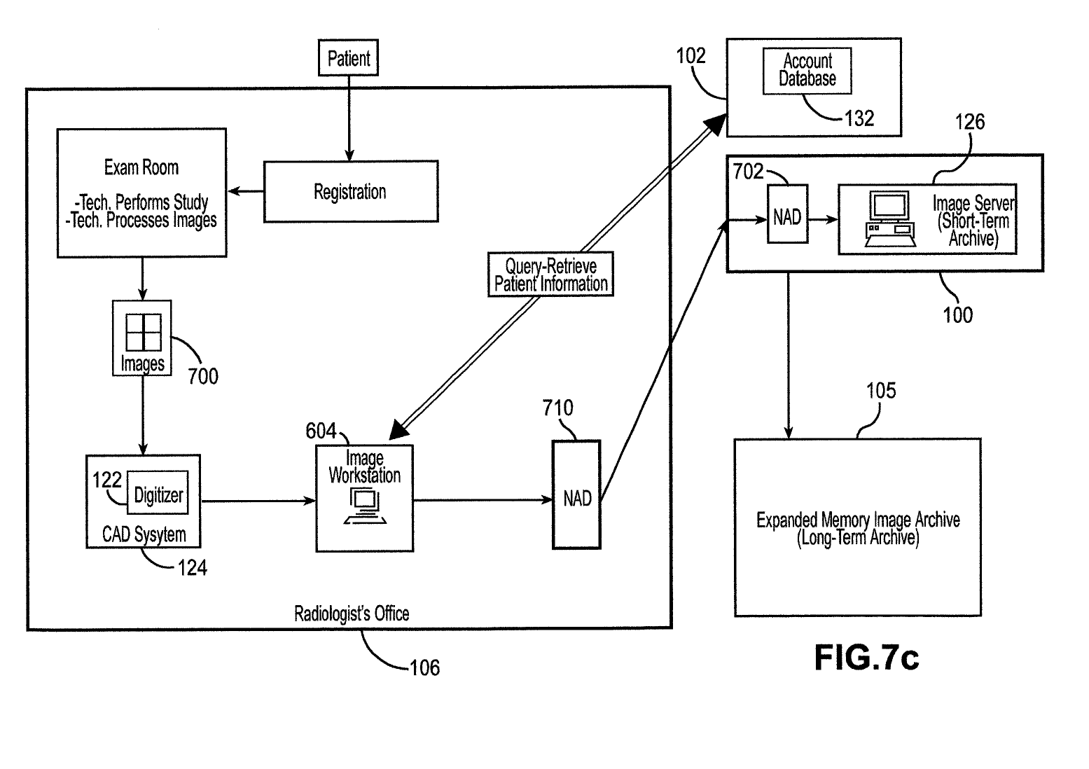

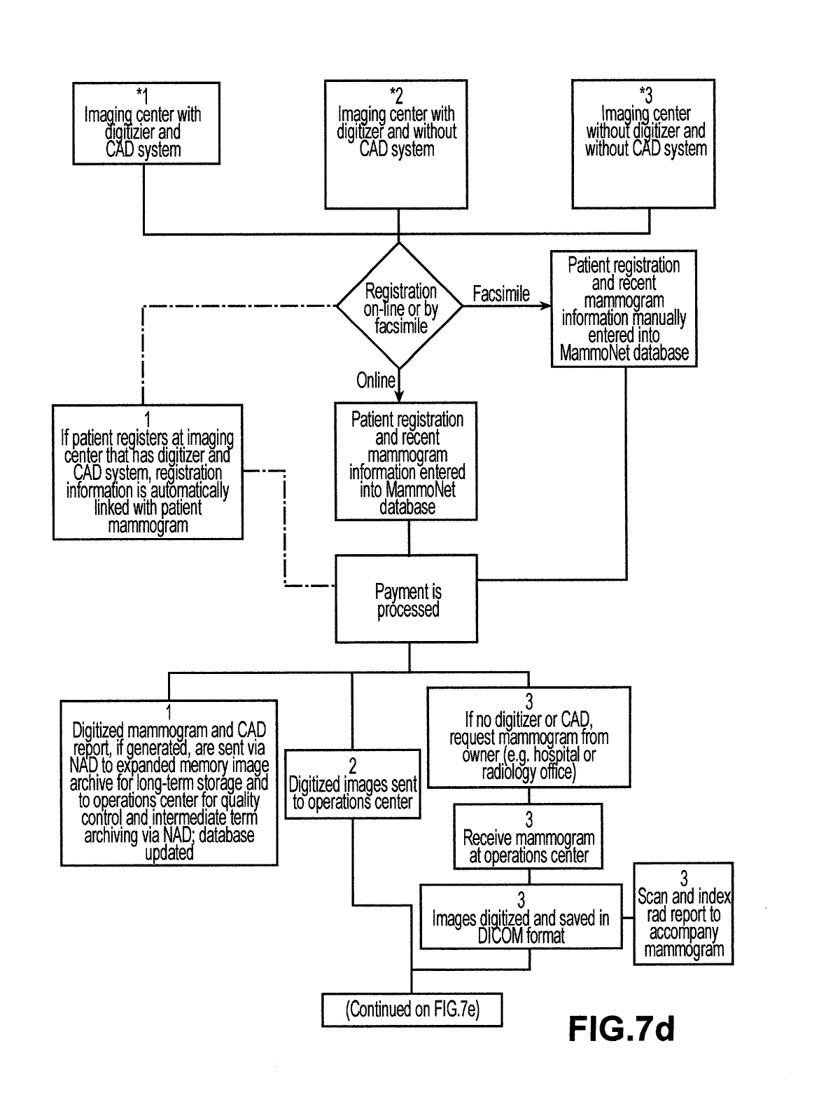

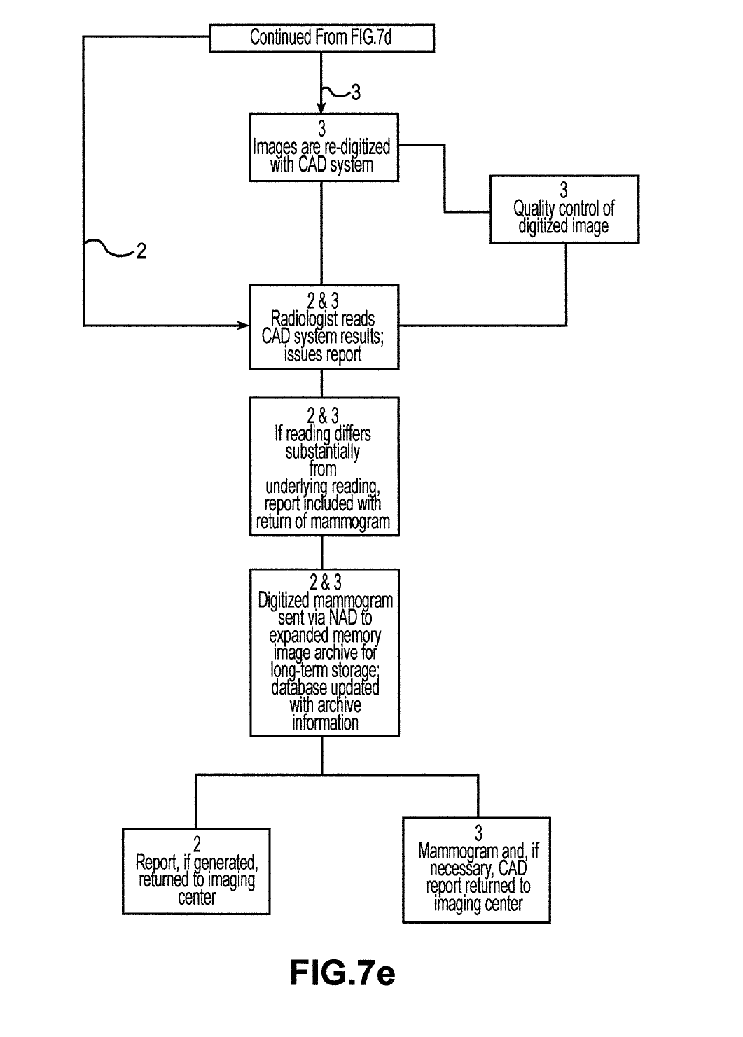

FIGS. 7a-7e illustrate preferred methods for acquiring mammography images. For these medical images, a critical aspect for streamlining data entry is the immediate acquisition and digital conversion of mammography images. This aspect eliminates the possibility of misplacing or losing the original mammogram films. Another unique aspect of these medical images is the large amount of memory storage they require, on the order of 168 MB for each mammography study. In addition, the method for storing mammography records must also incorporate the valuable assistance provided by computer-aided detection. Although FIGS. 7a-7e and the corresponding narrative describe a method for acquiring mammography images, one of ordinary skill in the art would recognize that the method applies equally well to other types of medical images, especially those requiring diagnostic-quality displays, large amounts of memory storage, and computer-aided detection.

The three principal methods by which mammograms are stored in a patient medical record depend on whether the imaging center taking the mammograms has a digitizer and a CAD system, e.g., ImageChecker™ by R2 Technology. Typically, imaging centers have no digitizer and no CAD system, have a digitizer but no CAD system, or have a CAD system and a digitizer. FIGS. 7a, 7b, and 7c illustrate these scenarios, respectively. In addition, FIGS. 7d and 7e are a flowchart outlining the general workflow of the acquiring mammograms and storing them in patient medical records, encompassing the three scenarios described below. Unless noted otherwise, each step illustrated in FIGS. 7d and 7e corresponds to the three types of imaging centers.

As shown in FIG. 7a, when an imaging center does not have a CAD system or a digitizer, the patient borrows the hard copy mammograms 700 and delivers them to operations center 100. A technician at operations center 100 logs the receipt of the hard copy mammograms 700 and, using digitizer 122, digitizes them, preferably into DICOM files, such that they appear on image workstation 604. The technician then tags the digitized medical images with the patient's name and UPI. With the patient preregistered, image workstation 604 queries account database 132 using the patient's name and UPI to retrieve the information necessary for completing bills. Image workstation 604 then forwards the digitized images to image server 126, which sends them for long term storage to expanded memory image archive 105 through a network accessing device (NAD) 702.

Concurrent with digitizing and storing images, a CAD system 124 digitizes and analyzes the hard copy mammograms 700. Optionally, digitizer 122 and the digitizer integral to CAD system 124 are the same digitizer. CAD system 124 electronically marks the images to note possible indications of disease and presents both the hard copy mammograms 700 and the marked electronic images to the radiologist operating CAD system 124. If CAD system 124 and the CAD system radiologist find no problems, operations center 100 returns the hard copy mammograms 700 to imaging center 106. If CAD system 124 and the CAD system radiologist do uncover a suspicious area and/or if the CAD system reading differs substantially from the underlying reading, the CAD system radiologist generates a report to send back to imaging center 106 with the hard copy mammograms 700. Optionally, if imaging center 106 does not participate in the service of the present invention, operations center 100 sends the hard copy mammograms 700 and a report (if needed) directly to the patient.

FIG. 7b shows the acquisition, analysis, and storage of mammograms for an imaging center 106 that has a digitizer 122 but no CAD system. In this scenario, a technician at imaging center 106 performs the mammography study and produces the hard copy mammograms 700. The technician then immediately digitizes the hard copy mammograms 700 with digitizer 122, preferably in a DICOM format. The digitized images appear on image workstation 604. The technician then tags the digitized medical images with the patient's name and UPI. With the patient preregistered, image workstation 604 queries account database 132 using the patient's name and UPI to retrieve the information necessary for completing bills. Image workstation 604 then forwards the digitized images through an image center NAD 710 and an operations center NAD 702 to image server 126. Image server 126 then sends the images for long term storage to expanded memory image archive 105 through NAD 702.

As operations center 100 is receiving and forwarding the digitized images to expanded memory image archive 105, operations center 100 runs the digitized images through CAD system 124 as described for FIG. 7a, but using digitized files instead of hard copy images. If the radiologist operating the CAD system 124 detects a problematic area and/or if the CAD system reading differs substantially from the underlying reading, the radiologist sends a report back to imaging center 106 by such means as e-mail or conventional mail.

FIG. 7c shows the acquisition, analysis, and storage of mammograms for an imaging center 106 that is fully equipped with a CAD system 124 and a digitizer 122. In this scenario, imaging center 106 performs the digitizing and CAD checking of the images and simply forwards the digitized image to operations center 100 for storage in expanded memory image archive 105. If the radiologist operating CAD system 124 detects a problem, the radiologist of imaging center 106 generates an internal report.

As shown in FIG. 7c, a technician at imaging center 106 performs the mammography study and produces hard copy mammograms 700. The technician immediately digitizes the hard copy mammograms 700 with digitizer 122, preferably in a DICOM format. Image workstation 604 displays the digitized image while, simultaneously, CAD system 124 marks problematic areas in the images for further evaluation by an interpreting radiologist, who generates a report if necessary. The technician then tags the digitized medical images with the patient's name and UPI. With the patient preregistered, image workstation 604 queries account database 132 using the patient's name and UPI to retrieve the information necessary for completing bills. Image workstation 604 then forwards the digitized images and report, if generated, through an image center NAD 710 and an operations center NAD 702 to image server 126. Image server 126 then sends the images and report, if generated, for long term storage to expanded memory image archive 105 through NAD 702. Preferably, before forwarding the images, image server 126 performs quality assurance checks on the images to verify diagnostic quality.

In the above three scenarios, each participating institution provides a telecommunications link to the MammoNet network. Additionally, in the preferred embodiment, to receive the hardware and software at no charge, each participating provider provides the staffing necessary to complete registration and digitizing, and in addition, guarantees a minimum number of patients annually, e.g., approximately 2500/year or 10/day.

As an alternative to the above three scenarios, the present invention anticipates advances in electronic display technologies that will allow physicians to read medical images without ever having to print hard copies. This advance will obviate the need for a digitizer. Thus, an alternate representative embodiment of the present invention provides that an imaging center records digitized images directly from a medical imaging machine, e.g., an x-ray machine. The digitized images would be electronically displayed for the physician's read and would also be analyzed by a CAD system. The imaging center would then send the digitized images and an interpreting radiologist's report, if generated, to the operations center for storage in a patient's medical record.

Once a patient enters her mammogram studies into the MammoNet system, the system and method of the present invention offer the patient the opportunity to integrate the MammoNet digitized mammograms into her complete medical record vault of My Medical Folder or as a part of MammoTracker. If Internet communications and hardware capabilities (especially display hardware) permit the transfer of the large image files associated with mammography studies, the present invention provides links within MammoTracker by which images can be retrieved from MammoNet. If technical capabilities do not handle the large image files, the MammoNet digitized mammograms are integrated into the complete medical record by listing summaries of the results in MammoTracker and providing instructions on how to physically retrieve the images through MammoNet.

In addition to patients of participating sites, the present invention can enroll patients of non-participating sites and store the mammograms of those non-participating sites. In such case, the patients mail their existing studies to operations center 100 for digitization and storage.

3) Medical Data Retrieval and Transmission

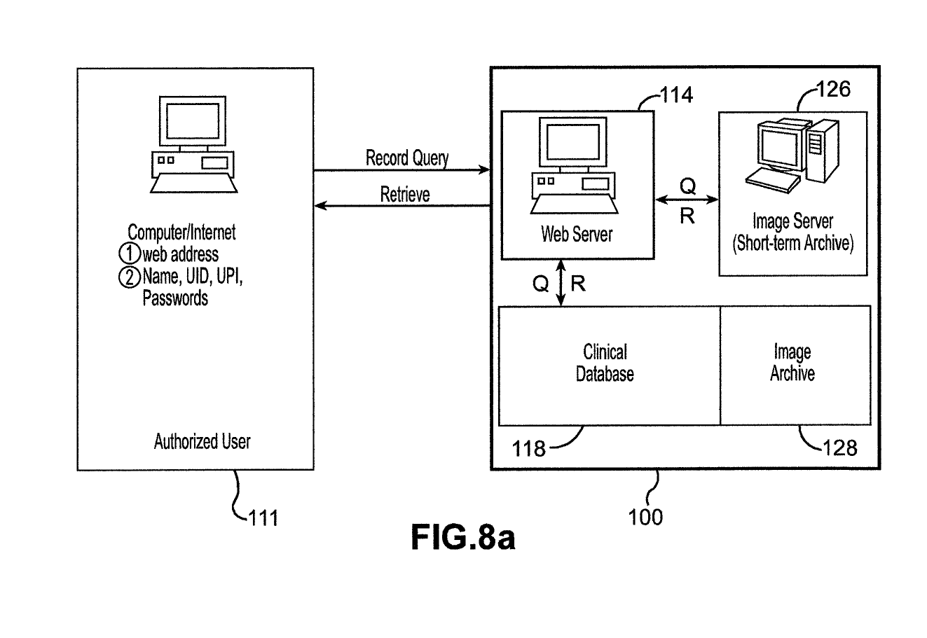

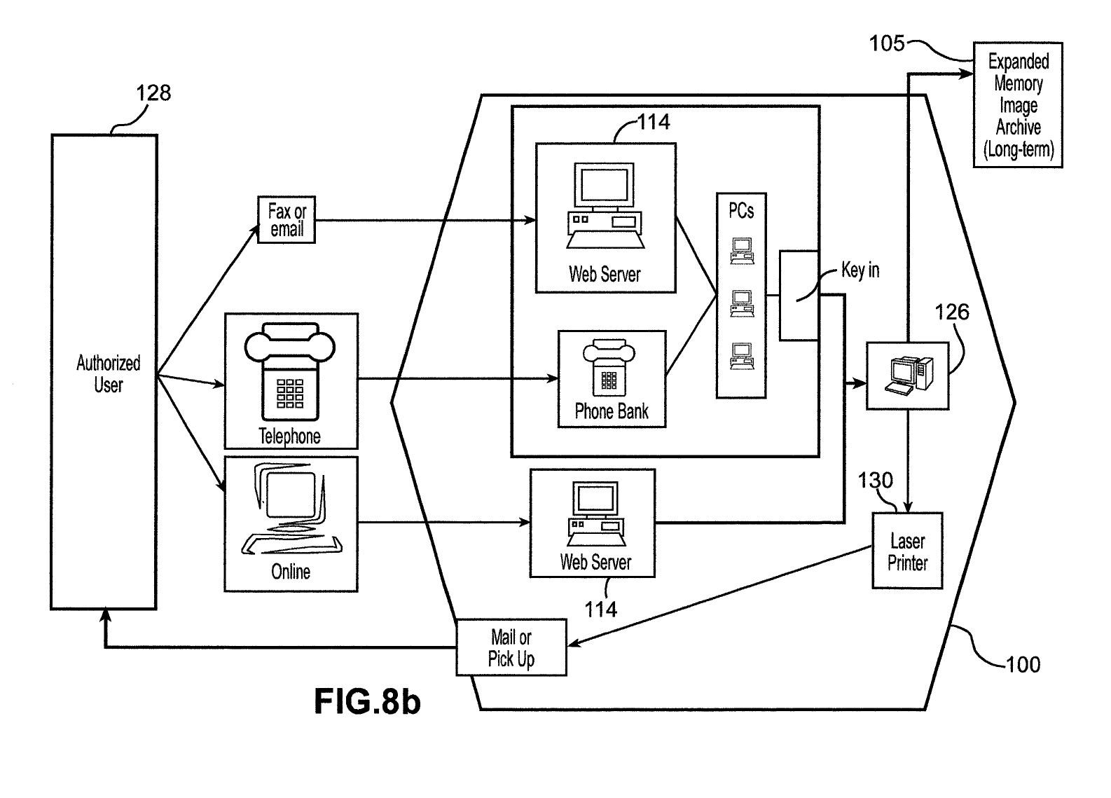

As provided by the present invention, data retrieval, like data acquisition, is convenient, accurate, easily available, and secure. Each patient has both a unique identifier and a password. State-of-the-art encryption technology secures the website. FIGS. 8a and 8b illustrate the methods by which the present invention retrieves medical records. FIG. 8a shows retrieval of records and non-mammography images. FIG. 8b shows retrieval of mammography images, from MammoNet. Although shown in the context of mammography images, one of ordinary skill in the art would appreciate that the system and method of FIG. 8b applies to other medical images as well, especially those requiring diagnostic-quality display, large amounts of memory storage, and computer-aided detection.

Since My Medical Folder and MammoTracker store information in specific, identifiable fields, authorized users, such as patients and physicians, can search by field to obtain particular information required for a particular situation. For example, should a patient have an appointment with a new physician, the patient can search for and retrieve only pertinent demographic and insurance information and can send that information electronically or by fax to the new physician. Having accessed and transmitted the specific information in advance, the patient avoids the time-consuming exercise of completing paperwork at the time of the visit. As an alternate to searching, patients and physicians may browse the patient medical record using the structured tabs.

As FIG. 8a shows, an authorized user, such as a patient or physician, accesses the medical record by first opening the web page of the present invention and logging in with the UPI and password or access code. Then, using a search function of the website (not shown in the figures), authorized user 111 formulates a query for the desired records (among My Medical Folder and MammoTracker) and sends the query to web server 114 of operations center 100. Responding to the query, web server 114 consults clinical database 118 for textual and scanned records, and consults image server 126 and image archive 128 for diagnostic-quality images. After identifying and retrieving the appropriate records, web server 114 returns the records through the Internet for display on the workstation of authorized user 111. Optionally, if the Internet communications or workstation hardware does not support diagnostic-quality images, a notification is sent to authorized user 111 reporting that the records have been pulled and/or copied, and will be returned via conventional means, e.g., by mail.

As shown in FIG. 8b, authorized user 111 (e.g., a patient, physician, or radiologist) accesses mammography images in MammoNet by facsimile or e-mail communication received by web server 114, by telephone request received by technicians at operations center 100, or by an online request through the Internet and web server 114. For facsimile, e-mail, and telephone requests, technicians at operations center 100 key the queries into image server 126. For online requests, image server 126 automatically receives the queries.

In response to the retrieval request, image server 126 uses the patient's UPI to look for the requested images in its short term cache and, if none are found, sends a search request to expanded memory image archive 105. Expanded memory image archive 105 retrieves the digitally encoded files and returns them to image server 126. If the Internet communications and the workstation of authorized user 111 can handle the large image files, image server 126 returns the images through web server 114 to the workstation of authorized user 111. If, for example, the technical capabilities are lacking, or if, for example, the physician prefers to examine a hard copy, image server 126 prints the digital files using laser printer 130, and forwards the resulting diagnostic-quality images to authorized user 111 (e.g., the patient or physician) by conventional means, e.g., mail.

A further preferred embodiment of the present invention provides immediate means for accessing and retrieving medical records. A first variation of this embodiment is a means for conveying critical medical information in emergency situations. A second variation is an immediate means for conveying a patient's entire medical record.

Once the patient has entered data into the My Medical Folder and MammoTracker, the present invention marks the information most critical for an emergency situation. The present invention then duplicates this information under the Global-ER tab as a single, concise GUI that displays this critical emergency data. In this manner, an emergency physician with Internet access can bring up the patient's medical record and immediately access the Global-ER file from the home page. The emergency physician would gain access to the Global-ER by asking the patient for the UPI and password, by looking at an information card the patient is carrying, or, if the patient agrees in advance to allow unrestricted access to the Global-ER page, by simply clicking on Global-ER and skipping the login (UPI and password).

Further, to make emergency data retrieval even more immediate, the present invention, in the first variation of this embodiment, provides a Patient Power Emergency Room Carrier (PERC) that stores the information listed in Global-ER in a portable form. The patient carries the PERC at all times, e.g., the PERC would be stored in a small memory card attached to a key chain. An example of a suitable storage card is a flash data storage product, like those produced by SanDisk™ Corporation of Sunnyvale, Calif. (e.g., PC Card ATA FlashDisk or CompactFlash).

An alternate embodiment utilizes a more durable and secure version of a flash memory card, classified as a Personal Information Carrier (PIC), also produced by SanDisk™ and modified by Informatech, Inc.™ (ITI). This PIC (also known as a P-Tag) is interchangeable with CompactFlash, and is used, for example, as a modified dog tag for U.S. Army soldiers. In any of these forms, the memory card is compatible with hospital computer terminals, e.g., using PCMCIA interfaces or CF ports provisioned at each hospital, provided by the medical record management service provider if necessary.

In addition, technology is emerging that will allow a P-Tag or other portable memory storage device to interface directly with the USB port of a desktop computer. Examples of this technology include the Thumbdrive™ by Trek 2000 International Ltd. of Singapore and the Q.™ USB hard drive by Agaté Technologies, Inc. of Milpitas, Calif. When appropriate and necessary, the present invention includes providing these interfaces, adapters, and emerging technologies. Thus, instead of requiring the emergency room staff to log onto the Internet and access the critical information page, the PERC enables instant plug-in and display capability.

According to the second variation of this embodiment, a Super PERC includes a patient's entire medical record behind the critical information, which would appear first. Thus, in addition to emergency applications, the patient could use the Super PERC to carry medical records around for viewing by individual physicians. Such applications are especially beneficial for patients who travel frequently and are often away from their primary physicians, e.g., airline pilots and flight attendants.

The amount of records that can be stored on the Super PERC is limited only by the storage capacity of the card. Provided with enough storage, a patient could use Super PERC instead of the website to store medical records. This option is beneficial in attracting patients to the service who may be uncomfortable posting private information on the World Wide Web, even though the information may be securely stored.

Whether the Super PERC is used exclusively or is used as a supplement to the website storage, operations center 100 would routinely update the Super PERC with changes made to the website records (e.g., Global ER and My Medical Folder). Optionally, a patient could update the Super PERC provided that the patient has access to the required computer programming and hardware. The PERC would also be updated in this manner.

In addition to updates that download new information from operations center 100 to a PERC or Super PERC, an alternate embodiment synchronizes operations center 100 and PERC or Super PERC in a two-way flow of data. In this manner, records could be changed on a PERC or Super PERC and uploaded to operations center 100. As one skilled in the art would appreciate, this implementation would require a stand-alone program operating on a patient's personal computer or handheld device. The program would read and make changes to a local copy of the patient's data. This implementation would also require a method for synchronizing the local and web-based copies of the patient's data. Because changes can be made to both copies concurrently, the synchronization method would identify the most recent records on each copy and would resolve conflicts between the copies, such as when a single record is modified on both copies in between synchronizations.

Related to the privacy concerns addressed by Super PERC, an alternate embodiment of the present invention provides the software applications of the present invention on a compact disk or other portable storage medium, instead of through the Internet. In this manner, a patient leery of posting information on the web can simply load the applications on her personal computer and save the medical record information to her computer's hard drive. The patient would then bring the medical record to the service provider on a portable storage medium, e.g., a floppy disk, so that the service provider could download the information onto a PERC or Super PERC. Alternately, the patient could obtain the hardware necessary to perform the downloading. Physicians would also have copies of the software applications so that the patient could bring her medical record to the physician's office and update it with the physician without using the web-based applications and data storage. As necessary, the service provider would provide updates to the patients and physicians for the non-web based software applications.

4) Customer Service and Technical Support

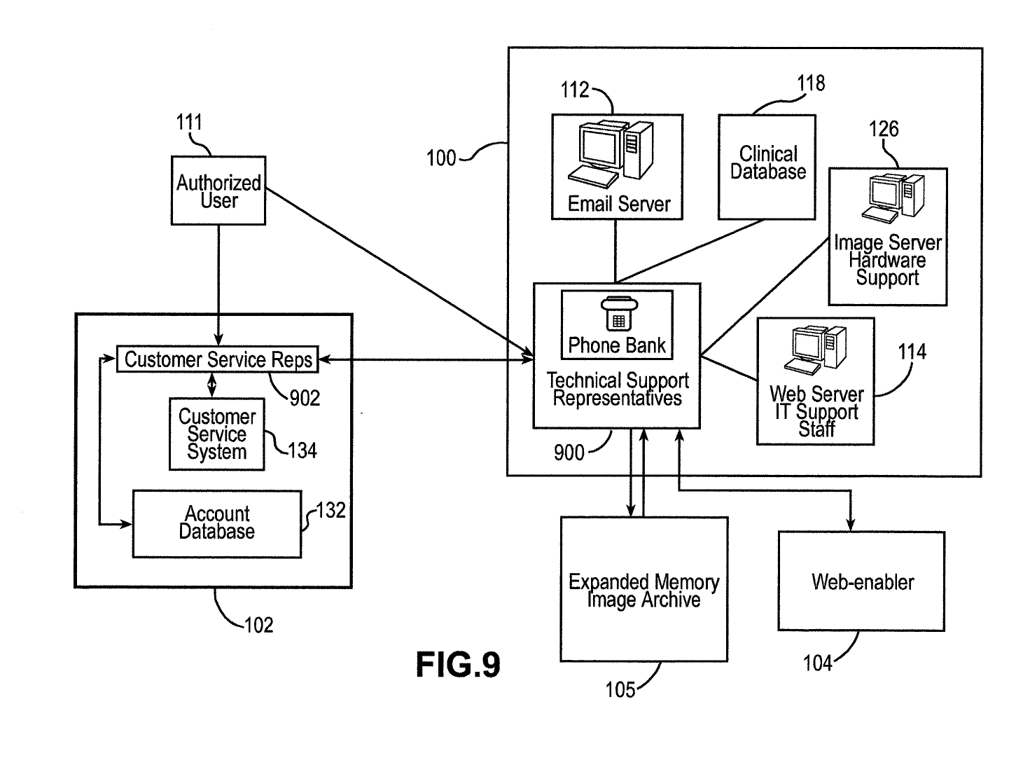

As shown in FIG. 9, according to a representative embodiment, customer service and technical support is a feature of the present invention. Operations center 100 provides technical support by having technical representatives 900 available by telephone and e-mail to solve problems such as data entry and data retrieval, as related to them by authorized user 111 or customer service representatives 902. From operations center 100, the technical representatives 900 can access e-mail server 112 for technical data and can perform diagnostic checks on the remaining components of operations center 100, e.g., web server 114, image server 126, clinical database 118, web-enabler 104, and expanded memory image archive 105.

For customer service, administrative center 102 has customer service representatives 902 available by telephone and e-mail to answer billing questions or other administrative concerns, as raised by authorized user 111 or technical service representatives 900. Customer service representatives 902 have access to account database 132 and customer service system 134 to meet these needs. Customer service system 134 is a GUI that gives the customer service representatives 902 the information, e.g., billing and legal policies, necessary to respond to patient inquiries.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

What is claimed is:

1. A method for managing medical records comprising the steps of:
(a) establishing an account for a patient;
(b) electronically storing text information associated with the patient;
(c) electronically storing paper documents associated with the patient in files capable of producing legible images;
(d) electronically storing medical images associated with the patient in files capable of producing diagnostic-quality images;
(e) associating the text information, the files of the paper documents, and the files of the medical images with the account; and
(f) providing an authorized user with access to the text information, the files of the paper documents, and the files of the medical images through a system.

2. The method of claim 1, further comprising the step of paying a physician to assist the patient in electronically storing the text information, the paper documents, and the medical images.

3. The method of claim 1, wherein the step of electronically storing the text information comprises entering textual data through a graphical user interface in communication with the system.

4. The method of claim 1, wherein the step of electronically storing the text information comprises transmitting textual data from an existing database.

5. The method of claim 4, wherein the existing database is one of Radiology Information System and Hospital Information System.

6. The method of claim 1, wherein the step of electronically storing the paper documents comprises one of scanning, faxing, and e-mailing the paper documents.

7. The method of claim 1, wherein the step of electronically storing the medical images comprises scanning the medical images into a high-resolution format file.

8. The method of claim 1, wherein the step of providing an authorized user with access comprises the steps of:
prompting the authorized user, through a graphical user interface, to query the system for a desired medical record, wherein the desired medical record is one of text information, a paper document, and a medical image;
retrieving the desired medical record from the system; and
transmitting the desired medical record through the graphical user interface to the authorized user.

9. The method of claim 8, wherein if the desired medical record is too large for efficient transmission, or if the authorized user does not have hardware capable of displaying the desired medical image, then the method comprises printing a hard copy of the desired medical record and forwarding the hard copy to the authorized user.

10. The method of claim 1, further comprising marking portions of the text information, the files of the paper documents, and the files of the medical images as critical information that is needed in an emergency situation, and
wherein the step of providing an authorized user with access comprises displaying the critical information on a single graphical user interface.

11. The method of claim 10, further comprising storing the critical information in a portable form.

12. The method of claim 11, wherein the portable form is one of a memory card and a personal information carrier.

13. The method of claim 1, wherein the text information, the paper documents, and the medical images are electronically stored in a portable form.

14. The method of claim 1, wherein the authorized user is one of a physician, a relative of the patient, and the patient.

15. The method of claim 1, wherein the step of establishing the account for the patient comprises assigning a unique patient identification and password to the patient,
wherein the authorized user is the patient, and
wherein the step of providing the authorized user with access includes requiring that the authorized user provide the unique patient identification and password.

16. The method of claim 15, further comprising the step of assigning an access code to a physician,
wherein the authorized user is the physician, and
wherein the step of providing the authorized user with access includes requiring that the authorized user provide the access code of the physician and the unique patient identification of the patient.

17. The method of claim 15, wherein the unique patient identification comprises:
(i) a series of first digits corresponding to one of a social security number of the patient and a random series;
(ii) one or more second digits indicating whether the series of first digits is the social security number of the patient or is the random series; and
(iii) a series of third digits corresponding to a date of birth of the patient.

18. The method of claim 1, wherein the step of electronically storing the medical images associated with the patient in files capable of producing diagnostic-quality images comprises the steps of:
(i) retrieving the medical images;
(ii) scanning the medical images into digitized images;
(iii) tagging the medical images with a name of the patient and a unique patient identification of the patient;
(iv) web-enabling the digitized images; and
(v) storing the web-enabled digitized images for access by the authorized user.

19. The method of claim 18, wherein the step of scanning the medical images into the digitized images comprises displaying the digitized images on an image workstation and storing the digitized images in a DICOM format.

20. The method of claim 18, further comprising querying an account database using the name and the unique patient identification of the patient to retrieve information necessary for completing bills.

21. The method of claim 18, wherein before web-enabling the digitized images, the method further comprises the step of storing the digitized images in a cache.

22. A system for managing medical records comprising:
(a) a scanner that digitally encodes images of paper documents into files that are capable of producing legible images;
(b) a clinical database that stores the files that are capable of producing legible images and that stores text information;
(c) a digitizer that digitally encodes medical images into files that are capable of producing diagnostic-quality images;
(d) an image archive that stores the files that are capable of producing diagnostic-quality images;
(e) an image server in communication with the scanner, the clinical database, the digitizer, and the image archive,
wherein the image server receives the files that are capable of producing diagnostic-quality images from the digitizer and transmits the files that are capable of producing diagnostic-quality images to the image archive, and
wherein the image server receives the files that are capable of producing legible images from the scanner and transmits the files that are capable of producing legible images to the clinical database; and
(f) a web server in communication with the image server, wherein the web server provides a plurality of users with access to the files that are capable of producing legible images, to the text information, and to the files that are capable of producing diagnostic-quality images.

23. The system of claim 22, further comprising a web-enabler that receives the files that are capable of producing diagnostic-quality images from the image server, temporarily stores the files that are capable of producing diagnostic-quality images, and web-enables the files that are capable of producing diagnostic-quality images.

24. The system of claim 22, further comprising an expanded memory image archive in communication with the image server, wherein the expanded memory image archive provides additional memory for storing the files that are capable of producing diagnostic-quality images.

25. The system of claim 22, further comprising:
(i) an application that marks critical information in the clinical database and the image archive; and
(ii) a means for storing the critical information in a portable form.

26. The system of claim 25, wherein the means for storing the critical information in a portable form is one of a smart card, a flash card, a compact flash card, a personal information carrier, and a portable memory storage device that interfaces directly with a USB port.

27. The system of claim 22, further comprising a means for storing, in a portable form, the files that are capable of producing legible images, the text information, and the files that are capable of producing diagnostic-quality images.

28. The system of claim 22, further comprising an e-mail server in communication with the web server and the plurality of users, wherein the e-mail server facilitates web-based transmission of the files that are capable of producing legible images, the text information, and the files that are capable of producing diagnostic-quality images from the web server to the plurality of users.

29. The system of claim 22, further comprising an account database that stores contact information, demographic information, and financial information of a patient in an account,
wherein the files that are capable of producing legible images and the text information of the clinical database are associated with the account, and
wherein the files that are capable of producing diagnostic-quality images of the image archive are associated with the account.

30. The system of claim 22, wherein the plurality of users comprise patients, physicians, and relatives of patients.

31. A method for managing medical records comprising the steps of:
(a) providing a patient with a system that electronically stores medical records;
(b) paying a physician to identify medical records to be stored in an account of the patient in the system; and
(c) entering the identified medical records into the account of the patient.

32. The method of claim 31, further comprising the step of paying the physician to identify additional medical records to be stored in the account of the patient and to identify medical records to be removed from the account of the patient.

33. The method of claim 31, further comprising the step of giving the physician access to the account of the patient to update the medical records.

34. The method of claim 31, further comprising the step of providing the patient with ownership of the medical records in the account.

35. The method of claim 31, wherein the medical records include text information, paper documents, and medical images.

36. A method for managing medical image records of a patient comprising the steps of:
(a) registering with an operations center through an imaging center; and
(b) if the imaging center does not have a digitizer or computer-aided detection (CAD) system,
delivering hard copy medical images of the patient to the operations center,
digitizing the hard copy medical images into digitized images at the operations center,
analyzing the digitized images using a CAD system at the operations center,
generating a report at the operations center if a problem is detected in the digitized images,
storing the digitized images and the report, if generated, in an archive, and
returning the hard copy medical images and the report, if generated, to one of the imaging center and the patient.

37. The method of claim 36, further comprising the step of:
(c) if the imaging center has a digitizer but does not have a CAD system,
digitizing hard copy medical images of the patient into digitized images at the imaging center,
transmitting the digitized images to the operations center,
analyzing the digitized images using a CAD system at the operations center,
generating a report at the operations center if a problem is detected in the digitized images,
storing the digitized images and the report, if generated, in an archive, and
returning the report, if generated, to one of the imaging center and the patient.

38. The method of claim 37, further comprising the step of:
(d) if the imaging center has a digitizer and a CAD system,
digitizing hard copy medical images of the patient into digitized images at the imaging center,
analyzing the digitized images with the CAD system at the imaging center,
generating a report at the imaging center if a problem is detected in the digitized images,
transmitting the digitized images and the report, if generated, to the operations center, and
storing the digitized images and the report, if generated, in an archive.

39. The method of claim 38, wherein if the imaging center has a digitizer and a CAD system, the method further comprises ensuring diagnostic quality of the digitized images at the operations center before storing the digitized images in the archive.

40. The method of claim 38, further comprising the steps of:
(e) receiving a query for the digitized images at the operations center from an authorized user;
(f) retrieving the digitized images from the archive;
(g) transmitting the digitized images through a network to the authorized user, if the authorized user's network connection and workstation support diagnostic-quality images; and
(h) printing a copy of the digitized images and forwarding the copy to the authorized user, if the authorized user's network connection and workstation do not support diagnostic-quality images.

41. The method of claim 40, wherein the medical images are mammograms.

42. The method of claim 40, wherein the authorized user is one of the patient, a physician, and a relative of the patient.

43. The method of claim 40, wherein the query is one of a telephone call, a facsimile, an e-mail, and an online request.

44. The method of claim 40, wherein the step of registering comprises assigning a unique patient identification to the patient,
wherein the digitized images are associated with the unique patient identification, and
wherein the query references the unique patient identification.

45. The method of claim 44, wherein the query includes a password if the authorized user is the patient, and
wherein the query includes an access code if the authorized user is a physician.

46. The method of claim 38, wherein the problem is one of an indication of disease and a difference between the report and an underlying read of the hard copy medical images.

47. The method of claim 38, wherein the method further comprises:
(e) if the imaging center records digitized images directly from a medical imaging machine,
analyzing the digitized images using a CAD system at the imaging center,
generating a report at the imaging center if a problem is detected in the digitized images,
transmitting the digitized images and the report, if generated, to the operations center, and
storing the digitized images and the report, if generated, in an archive.

48. A system for managing medical records comprising the steps of:
(a) means for establishing an account for a patient;
(b) means for electronically storing text information associated with the patient;
(c) means for electronically storing paper documents associated with the patient in files capable of producing legible images;
(d) means for electronically storing medical images associated with the patient in files capable of producing diagnostic-quality images;
(e) means for associating the text information, the files of the paper documents, and the files of the medical images with the account; and
(f) means for providing an authorized user with access to the text information, the files of the paper documents, and the files of the medical images.

49. The system of claim 48, wherein the text information includes at least one of medical data, contact information, demographic information, and financial information associated with the patient.

50. The system of claim 48, wherein the paper documents include at least one of electrocardiograms, echocardiograms, and laboratory reports associated with the patient.

51. The system of claim 48, wherein the medical images are mammograms of the patient.

52. The system of claim 48, wherein the means for electronically storing text information, the means for electronically storing paper documents, and the means for electronically storing medical images comprise a portable memory storage device.

53. The system of claim 52, wherein the portable memory storage device is one of a smart card, a flash card, a compact flash card, a personal information carrier, and a portable memory storage device that interfaces directly with a USB port.
